(19) United States
(12) Patent Application Publication
(10) Pub. No.: US 2026/0258254 A1
(43) Pub. Date: Sep. 3, 2026

(54) PRIMER COATING SYSTEM AND COMPOSITION FOR ACHIEVING EXCELLENT WATER RESISTANCE

(71) Applicant: BASF COATINGS GMBH, Muenster (DE)

(72) Inventors: Md Ershad MISTRI, Mangalore (IN); Rajkumar JANA, Mangalore (IN); Ahammad ARIF, Mangalore (IN); Donald H. CAMPBELL, Hartland, MI (US); Qingling ZHANG, Southfield, MI (US)

(21) Appl. No.: 18/867,649

(22) PCT Filed: Jun. 7, 2023
(86) PCT No.: PCT/EP2023/065228

§ 371 Date: Nov. 20, 2024

(30) Foreign Application Priority Data
Jun. 9, 2022 (EP) 22178185.9

(51) Int. Cl. C09D 5/00; C09D 7/62; C09D 175/04

(52) U.S. Cl. CPC C09D 5/002; C09D 7/62; C09D 175/04

(57) ABSTRACT

Disclosed herein are a primer coating system including at least two components A) and B) being different and separate from one another, where component A) includes at least constituent a2) and at least one condensation product a3), where component B) includes at least one organic constituent b2) bearing on average two or more NCO-groups, a primer coating composition obtained by mixing at least components A) and B) with each other or a 1K primer coating composition including the condensation product a3), a use method of using the primer coating composition for improving water and/or moisture resistance of cured coating films and multilayer coating obtained therefrom, a method of coating a substrate by at least applying the primer coating composition, a coated substrate obtained therefrom, a method of preparing a multilayer coating system including at least one primer coating film obtained from the primer coating composition, and a multilayer coating system.

The present invention relates to a primer coating system comprising at least two components A) and B), a primer coating composition obtainable either by mixing these components of the primer coating system with each other or a 1K primer coating composition per se, a use of the primer coating composition for improving water and/or moisture resistance of a cured primer coating film obtainable therefrom and/or of a cured multilayer coating system containing such a cured film, a method of coating a substrate making use of said primer coating composition, a method of preparing a multilayer coating system making use of primer coating composition in order to provide a primer coating film within this system, and a multilayer coating system present on a substrate comprising at least three layers, one of them being a layer obtained from said primer coating film.

### BACKGROUND OF THE INVENTION

In typical automotive coating processes, usually multiple layers are applied to the surface of a suitable substrate in form of a multilayer coating system. In particular, in case plastic or fiber reinforced plastic substrates are used, at least a primer, at least one basecoat, and a topcoat, in particular a clearcoat as outermost layer, are applied in this sequence. At least the basecoat and the topcoat are nowadays typically applied making use of a wet-on-wet-application. Afterwards the coated substrate is passed through an oven at temperatures to cure at least the basecoat(s) and the topcoat such as the clearcoat simultaneously in, e.g., a 2C1B process. In some cases, also the primer coat is cured at this stage together with the basecoat(s) and topcoat, in particular clearcoat, e.g., in a 3C1B process.

There are quite a number of requirements necessary, which have to be fulfilled and/or met by the single layers present within the multilayer coatings used in the automotive industry and by the multilayer coatings as such due to regulations, but also due to quality standards set by the automotive industry. Thus, the multilayer coatings have to exhibit or display a number of desired characteristics to at least a sufficient extent in order to meet these requirements.

For example, any avoidance of film or layer failure due to an exposure to external harsh weather conditions, mainly due to moisture permeation through the coated film of the multilayer coating to the substrate, is desired. Thus, excellent water vapor barrier properties are desired to be achieved in order to avoid any swelling of the substrates used, especially polar substrates, and to maintain durable appearance combined with good adhesion properties, in particular between the primer and the substrate. For the exterior body parts of an automobile, the provision of such durable coating layers with good adhesion properties has become one of the key requirements to maintain the lifetime of the painted automotive body parts. In case of plastic substrates including reinforced plastic substrates, durable coating layers are essential, so that these can be used as a replacement to metal parts. Specially for polar substrates maintaining durable coating layers on the substrate is challenging due to the tendency of moisture uptake from air at ambient conditions.

Often, conventional automotive coating systems exhibit only poor water vapor barrier properties resulting in defects, in particular appearance defects, in the painted parts after a certain period of time.

Thus, there is a need to provide new coating films and multilayer coating systems on substrates, in particular on plastic substrates including reinforced plastic substrates, with no or at least less moisture permeability than observed for conventional coating films and multilayer coating systems, i.e., which display excellent water vapor barrier properties (water resistance), and which consequently allow maintaining of durable coating films and multilayer coating systems with excellent appearances even after a long time.

### Problem

It has been therefore an objective underlying the present invention to provide coating films and multilayer coating systems on substrates, in particular on plastic substrates including reinforced plastic substrates, with no moisture permeability or at least less moisture permeability than observed for conventional coating films and multilayer coating systems, hence displaying excellent water vapor barrier properties, and which allow, in particular as a result of these improved barrier properties, maintaining of durable coating films and multilayer coating systems with excellent appearances even after a long time.

### Solution

This objective has been solved by the subject-matter of the claims of the present application as well as by the preferred embodiments thereof disclosed in this specification, i.e., by the subject matter described herein.

A first subject-matter of the present invention is a primer coating system comprising at least two components A) and B) and optionally at least one further component C) being different from one another and being separate from each other,
wherein component A) comprises at least constituents a2) and a3) and optionally at least one constituent a1), which are different from one another, namely
   optionally at least one organic solvent a1),
   at least one polymer a2), which contains functional groups, that are reactive towards NCO-groups, which preferably is at least one OH-functional polymer, and
   at least one condensation product a3), which is obtainable at least by reaction of (i) at least one organosilane bearing at least one hydrolyzable group with (ii) at least one kind of silica, wherein the molar ratio of the at least one organosilane and the at least one kind of silica used to each other preferably is in a range of from 10:1 to 1:1,
wherein component B) comprises at least two constituent b2) and optionally at least one constituent b1), which are different from one another, namely
   optionally at least one organic solvent b1), and
   at least one organic constituent b2) bearing on average two or more NCO-groups, and
wherein optional component C) is a reducer component and comprises at least one organic solvent c1).

A further subject-matter of the present invention is a primer coating composition,
which is obtainable by mixing at least components A) and B) and optionally C) of the inventive primer coating system with each other
or
which at least comprises constituents (i), (ii) and (iii) and optionally also (iv), which are different from one another, namely
(i) at least one organic solvent, which preferably corresponds to the at least one organic solvent a), b1) and/or c1) as defined for the inventive primer coating system,
(ii) at least one film-forming polymer, which is self-crosslinking or externally crosslinking, preferably is externally crosslinking, more preferably which corresponds to the at least one polymer a2), which contains functional groups, that are reactive towards NCO-groups, as defined for the inventive primer coating system,
(iii) at least one condensation product, which corresponds to the condensation product a3) as defined for the inventive primer coating system, and
(iv) optionally at least one crosslinking agent at least in case the at least one film-forming polymer (ii) is an externally crosslinking polymer, which crosslinking agent preferably is selected from blocked polyisocyanates, melamine formaldehyde resins and mixtures thereof.

A further subject-matter of the present invention is a use of said primer coating composition for improving water and/or moisture resistance of a cured primer coating film obtainable therefrom and/or of a cured multilayer coating system containing at least one cured primer coating film, said cured primer coating film being obtainable from said primer coating composition.

A further subject-matter of the present invention is a method of coating a substrate comprising at least a step 1) and optionally also step 1a), namely
1) applying said primer coating composition at least partially to at least one surface of an optionally pre-coated substrate and forming a primer coating film on said surface,
1a) and optionally at least one further step 1a) of curing the at least one primer coating film obtained after step 1) to obtain at least one cured primer coating layer onto said surface.

A further subject-matter of the present invention is a coated substrate, which is obtainable by said method.

A further subject-matter of the present invention is a method of preparing a multilayer coating system on at least one surface of an optionally pre-coated substrate comprising at least steps 1) to 3) and optionally 4), namely
1) applying a first coating composition at least partially to at least one surface of an optionally pre-coated substrate and forming a first coating film on said surface, wherein the first coating composition is said primer coating composition,
2) applying at least one basecoat composition as at least one second coating composition to the first coating film present on the substrate obtained after step 1), preferably prior to curing the first coating film, and forming a second coating film, which is preferably adjacent to the first coating film, and
3) applying a topcoat composition, preferably a clearcoat composition, as third coating composition to the second coating film present on the substrate obtained after step 2), preferably prior to curing the second coating film and forming a third coating film, which is preferably adjacent to the second coating film and which preferably is the outermost coating film of the formed multilayer coating system, and
4) optionally jointly curing the first, second and third coating films to obtain a multilayer coating system comprising cured first, second, and third coating layers.

A further subject-matter of the present invention is a multilayer coating system being present on an optionally pre-coated substrate, preferably obtainable by said method of preparing a multilayer coating system, and comprising at least three coatings layers L1, L2 and L3 being different from one another and preferably being positioned adjacently to each other, namely
a first coating layer L1 applied over at least a portion of an optionally pre-coated substrate, said layer L1 being obtainable from an inventive primer coating composition,
a second coating layer L2 applied over the first coating layer L1, and
a third coating layer L3 applied over the second coating layer L2, wherein the third coating layer L3 preferably is the outermost coating layer of the multilayer coating system.

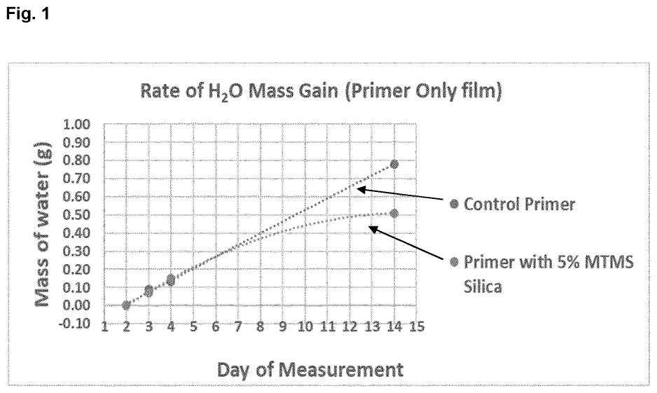

It has been in particular surprisingly found that water permeability of free-standing cured primer films, said films being obtained from an inventive primer coating composition, which in turn has been obtained from an inventive primer coating system, could be significantly lowered due to the presence of condensation product a3) within component A) of the primer coating system. As it is shown in FIG. 1 a significant difference in water vapor permeability is observed: the film obtained from an inventive primer coating composition comprising constituent a3) is about 35% less permeable than a control film obtained from a primer coating composition not comprising any constituent a3). Hence, without the presence of constituent a3) a poorer moisture barrier property is observed.

Further, it has been in particular surprisingly found that a significantly less moisture (water) uptake (about 40 wt. % less) after humidity exposure and storage was observed for substrates, in particular plastic substrates such as carbon fiber reinforced plastic substrates including carbon fiber reinforced polyamide, that were coated with a multilayer coating system comprising a primer layer derived from primer film, which has been obtained from a primer coating composition that has in turn been obtained from the inventive primer coating system comprising constituent a3) in its component A), compared to substrates that were coated with an identical multilayer coating system but containing a control primer film instead of an inventive primer coating film, said control primer film not containing any constituent a3). Moreover, it has been further surprisingly found that this effect can be observed for multiple different kinds of substrates and also is independent of the nature of the basecoat materials (solventborne and waterborne basecoats) used as intermediate coats for preparing the multilayer coating systems.

In particular, it has been further surprisingly found that in case of a carbon fiber reinforced polyamide (PA-CF) substrate bearing a multilayer coating system, appearance is dynamic, when a conventional primer is used, in particular that appearance gets poorer over time under ambient conditions, likely due to the highly polar nature of the polyamide substrate, which swells by absorbing moisture from air at ambient conditions. This undesired effect has not been observed when an inventive primer film comprising constituent a3) was used.

Further, it has been found that the inventive primer coating composition can be cured at low temperature as low as 50° C., which is energy efficient and eco-friendly, and is particularly advantageous when the substrates used are plastic substrates.

It has been additionally found that an inventive primer coating film obtained from an inventive primer coating composition has an ability to at least partially also cure a basecoat film applied on top of said primer coating film even at temperatures as low as 50° C. due to isocyanate migration from the primer film into the basecoat film, especially when the primer coating composition used contains an excess of constituent b2) bearing on average two or more NCO-groups such that upon migration of said constituent into the aforementioned basecoat film, applied on top of a primer coating film obtained from the primer coating composition onto a substrate, at least partial curing of the basecoat film is achieved, when said film contains at least one preferably polymeric constituent, which contains functional groups that are reactive towards the NCO-groups of constituent b2).

### DETAILED DESCRIPTION OF THE INVENTION

The term “comprising” in the sense of the present invention, in connection for example with the primer coating composition or one of the components of the primer coating system, preferably has the meaning of “consisting of”. With regard, e.g., to the primer coating composition or one of the components of the primer coating system it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the coating compositions such as the primer coating composition add up to 100 wt.-%, based in each case on the total weight of the coating composition. The same applies in relation to each component of a coating system such as component A) or B) of the primer coating system: The proportions and amounts in wt.-% (% by weight) of any of the constituents given hereinafter, which are present in one of these components add up to 100 wt.-%, based in each case on the total weight of the respective component.

### Primer Coating System

As outlined hereinbefore the primer coating system comprises at least two components A) and B) and optionally at least one further component C) being different from one another and being separate from each other, i.e., is a two- (2K-) or multi-component coating system. Separate from each other in this context means that components A) and B) and optionally C) of the coating system can be stored separately until they are mixed with each other in order to prepare a primer coating composition. In case the coating system is a two-component coating system, it preferably consists of components A) and B). Upon mixing of at least the two components A) and B) and applying the resulting composition to a surface of a substrate, a polyurethane or polyurethane-based coating film is preferably formed at least by reaction of OH-groups of the at least one constituent a2) with the isocyanate groups of the at least one constituent b2).

Preferably, both components A) and B) and also optional component C) of the coating system are free or essentially free of water. The same applies to the coating compositions obtainable therefrom. In the sense of the present invention the term “free of water” preferably means that no water at all is present. In the sense of the present invention the term “essentially free of water” preferably means that essentially no water is present. This means that at least no water is added on purpose to any of the inventively used components A) and B) and optionally C) and to the coating composition obtainable therefrom. It may, however, not be ruled out that remaining residues of water formed upon preparation of any of the constituents used for preparing the inventively used components A) and B) and optionally (C) are present therein. Preferably, the amount of any water present in each of the component A) and B) and optionally C) is less than 1 wt.-%, more preferably less than 0.5 wt.-%, even more preferably less than 0.1 wt.-%, still more preferably less than 0.05 wt.-%, yet more preferably less than 0.01 wt.-%, in particular less than 0.005 wt.-% or less than 0.001 wt.-%, in each case based on the total weight of component A) or B) or optionally C). Preferably, both components A) and B) and also optional component C) of the coating system are solventborne, i.e., organic solvent(s)-based. Thus, preferably, the coating system is not a waterborne, i.e., not an aqueous coating system.

### Component A)

Component A) comprises at least constituents a2) and a3) as well as optionally a1), which are different from one another, but may additionally comprise further optional constituents.

Preferably, component A) of the primer coating system has a total solids content, which is >20 wt.-%, preferably >25 wt.-%, more preferably >30 wt.-%, based on the total weight of component (A). The total solids content of component A) of the primer coating system is preferably in a range of from >20 to 60 wt.-%, more preferably of from 25 to 50 wt.-%, even more preferably of from 30 to 45 wt.-%, based in each case on the total weight of component A). The total solids content, in other words the non-volatile fraction, is determined in accordance with the method described hereinafter.

### Optional Constituent a1)

Optional constituent a1) is at least one organic solvent. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. Component A) may comprise more than one organic solvent a1).

Preferably, the amount of constituent a1) in component (A) is in the range of from 10 to 80 wt.-%, more preferably of from 25 to 75 wt.-%, even more preferably of from 40 to 70 wt.-%, based in each case on the total weight of component A).

### Constituent a2)

Constituent a2) is at least one polymer, which contains functional groups, that are reactive towards NCO-groups such as OH-groups, thiol groups, carbamate groups, COOH-groups and/or amino groups. Preferably, constituent a2) is an OH-functional polymer. Constituent a2) such as an OH-functional polymer preferably functions as film-forming binder. For the purposes of the present invention, the term “binder” is understood in accordance with DIN EN ISO 4618 (German version, date: March 2007) to be the non-volatile constituent of a coating composition, which is responsible for the film formation. Pigments and/or fillers contained therein are thus not subsumed under the term “binder”. Preferably, constituent a2) represents the main binder. As the main binder in the sense of the present invention, a binder constituent is preferably referred to, when there is no other binder constituent in the coating composition or a component used for its preparation, which is present in a higher proportion based on the total weight of the coating composition or component.

The term “polymer” is known to the person skilled in the art and, for the purposes of the present invention, encompasses polyadducts and polymerizates as well as polycondensates. The term “polymer” includes both homopolymers and copolymers.

If constituent a2) is at least one OH-functional polymer, it preferably comprises on average two or more OH-groups.

Any type of polymers having functional groups, that are reactive towards NCO-groups can be used as constituent a2). Examples are (meth)acrylic polymers, polyesters, polyurethanes, polyureas and polyethers as well as mixtures thereof.

Preferably, constituent a2) is at least one OH-functional (meth)acrylic polymer, more preferably at least one OH-functional (meth)acrylic polymer, which has been modified with at least one chlorinated polyolefin. An example of such a polymer is Acrydic® CL-408.

Preferably, component A) of the primer coating system comprises the at least one constituent a2) in an amount in a range of from 5.0 to 50.0 wt.-%, more preferably of from 10.0 to 45.0 wt.-%, even more preferably of from 15.0 to 40.0 wt.-%, still more preferably of from 17.5 to 35.0 wt.-%, in each case based on the total weight of component A).

### Constituent a3)

Constituent a3) is at least one condensation product, which is obtainable at least by, preferably which is obtainable by, reaction of (i) at least one organosilane bearing at least one hydrolyzable group with (ii) at least one kind of silica. Condensation product a3) is herein also referred to as “condensate”. It has been found that condensation product a3) leads to an excellent water vapor barrier property of a cured coating film derived from a primer coating composition being in turn obtainable from mixing component A) and B) and optionally C) with each other.

Preferably, molar ratio of the at least one organosilane and the at least one kind of silica used for preparing condensation product a3) to each other is in a range of from 10:1 to 1:1, more preferably of from 8:1 to 1:1, even more preferably of from 6:1 to 1:1, yet more preferably of from 4:1 to 1:1, still more preferably of from 4:1 to 1.1:1, yet more preferably of from 4:1 to 1.5:1, most preferably of from 4:1 to 2:1.

Preferably, the at least one condensation product a3) is present in component A) in an amount in a range of from 1.0 to 25.0 wt.-%, more preferably of from 2.0 to 20.0 wt.-%, even more preferably of from 3.0 to 17.5 wt.-%, yet more preferably of from 4.0 to 15.0 wt.-%, still more preferably of from 5.0 to 14.0 wt.-%, even more preferably of from 6.0 to 13.0 wt.-%, most preferably of from 7.0 to 12.0 wt.-%, in each case based on the total weight of component A).

Preferably, condensation product a3) has an average particle size in a range of from 10 to 100 nm, more preferably of from 15 to 80 nm, even more preferably of from 20 to 70 nm, yet more preferably of from 25 to 60 nm, still more preferably of from 30 to 50, most preferably of from 35 to 45 nm, in each case measured by DLS (dynamic light scattering). The DLS method used is hereinafter specified in the ‘methods’ section. Preferably, the average particle size is measured at a high shear viscosity of 5 to 15 cP measured by using a CAP 2000 viscometer.

The term “silica” used in this context is a clear term for a person skilled in the art and refers to SiO₂. Preferably, the at least one kind of silica used is used in form of a basic or acidic, preferably basic, aqueous dispersion of preferably colloidal silica particles. Preferably, the silica particles have an average particle size of the silica ranging from 5 to about 300 nm, more preferably from 5 to 200 nm, even more preferably from 7.5 to 100 nm, still more preferably of from 7.5 to 50 nm, most preferably from 10 to 30 nm. The average particle size is measured via DLS. The DLS method being used is hereinafter specified in the ‘methods’ section and is the same method, which is also used for determining the average particle size of condensation product a3).

As outlined hereinbefore, both acidic and basic colloidal silica dispersions can be used. Colloidal silica dispersions having a low alkali content are, however, preferred. Commercially available silica products, which can be used include, for example, Ludox® (Sigma Aldrich), Snowtex® (Nissan Chemical), Bindzil® (AkzoNobel), Nalco® Colloidal Silica (Nalco Chemical Company), and Levasil® (AkzoNobel) products. Particularly preferred colloidal silica products that can be used include Nalco® 1034A (Nalco Chemical Company), Snowtex® 040, Snowtex ST-033 and Snowtex® OL-40 (Nissan Chemical), Ludox®AS40 and Ludox®HS 40 (Sigma-Aldrich), Levasil 200/30 and Levasil® 200 S/30 (now Levasil CS30-516P) (AkzoNobel) and Cab-OSperse® A205 (Cabot Corporation) etc.

The at least one organosilane bearing at least one hydrolyzable group may optionally comprise and preferably comprises at least one non-hydrolyzable group, which preferably is an organic, preferably aliphatic, residue having 1 to 10 carbon atoms, which optionally further comprises at least one functional group.

Preferably, the at least one organosilane bearing at least one hydrolyzable group is a monosilane and has at least two, particularly preferably at least three hydrolyzable groups X, and/or is at least one bis(silane), which preferably has at least four, particularly preferably six hydrolyzable groups X. It is, however, also possible to employ monosilanes with four hydrolyzable groups X, i.e., monosilanes not containing any non-hydrolyzable residues, such as tetramethoxysilane and/or tetraethoxysilane.

Preferably, the at least one organosilane bearing at least one hydrolyzable group is an organosilane of general formula (1) and/or (2)

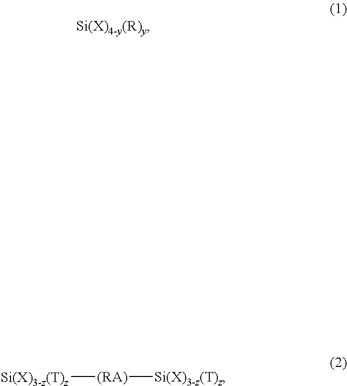

wherein in the case of general formula (1)
X is each independently a hydrolyzable group, preferably each independently selected from O—C₁₋₄ alkyl,
the parameter y is 0 or an integer in the range from 1 to 3, preferably is at least 1, preferably exactly 1, and
R is a non-hydrolyzable organic residue, preferably aliphatic residue, which preferably has 1 to 10 carbon atoms, wherein at least one of residues R optionally comprises at least one functional group,
and wherein in the case of general formula (2)
X represents, in each case independently of one another, a hydrolyzable group and is preferably selected, in each case independently of one another, from O—C₁₋₄-alkyl,
RA represents a divalent non-hydrolyzable organic residue, preferably aliphatic residue, which preferably has 1 to 10 carbon atoms, which preferably contains no functional group,
the parameter z is in each case 0 or an integer in the range from 1 to 3, preferably in each case 0 or 1, more preferably in each case 1, and
T is a non-hydrolyzable organic residue, preferably aliphatic residue, which preferably has 1 to 10 carbon atoms, which is different from the residue RA, and which optionally comprises at least one functional group.

Examples of suitable functional groups are in particular thiol groups, amino groups, epoxide groups, in particular glycidoxy, epoxycyclohexyl and/or epoxycyclohexylethyl, OH-groups that are protected via a suitable protecting group, (meth)acrylate groups, vinyl groups, allyl groups, (meth)acryloxy groups, episulfide groups, ureido groups, thioureido groups, ether groups, thioether groups, sulfide groups, in particular disulfide trisulfide, tetrasulfide, pentasulfide, hexasulfide and/or polysulfide groups, xanthate groups, trithiocarbonate groups, dithiocarbonate groups, isocyanurato groups, and/or —Si(OR)₃ group wherein R₃ is an aliphatic residue, which preferably has 1 to 10 carbon atoms.

Examples of suitable organosilanes bearing at least one non-hydrozable group are, e.g., (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane, (3-glycidyloxypropyl)triethoxysilane, bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine, bis(4-butyltriethoxysilyl)amine, methyl trimethoxysilane, methyl triethoxysilane, ethyl trimethoxysilane, ethyl triethoxysilane, propyl trimethoxysilane, and/or propyl triethoxysilane.

Preferably, the condensation reaction of the at least one organosilane bearing at least one hydrolyzable group with the at least one kind of silica takes place in aqueous medium and preferably is catalyzed by at least one preferably organic acid.

Preferably, the at least one kind of silica is added to the at least one organosilane in the presence of water, preferably of 0.5-2.0 moles of water, based on the molar amount of the at least one organosilane, and in the presence of a preferably catalytic amount of at least one acid, more preferably of at least one organic acid such as acetic acid. The addition preferably takes place at a temperature between 0 and 10° C. After stirring of the resulting mixture, preferably at room temperature (18 to 23° C.) for 10 to 18 hours, preferably a further catalytic amount of at least one acid, more preferably of at least one organic acid such as acetic acid acetic acid and at least one ammonium salt such as tetrabutylammonium acetate (TBAA) as additional catalyst is added. Then, the resulting mixture is preferably stirred for 1 to 10 hours. Preferably, the pH value of the mixture is maintained at pH 3 to 6. Then, the resulting mixture preferably is diluted with, e.g., in a 1:1 weight ratio, with at least one organic solvent, which is miscible with water such as isopropanol (IPA).

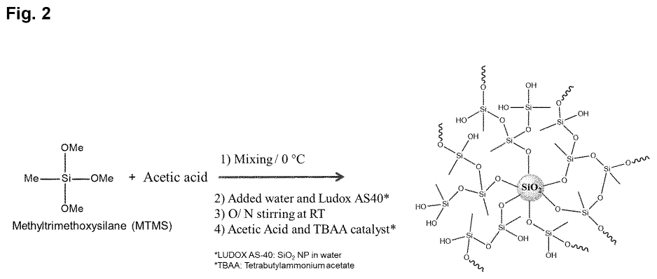

The preparation of an exemplary condensation product a3) prepared from methyltrimethoxysilane (MTMS) as organosilane is outlined in FIG. 2.

### Constituents a4) and a5)

Preferably, component A) of the primer coating system further comprises at least one catalyst a4) suitable for crosslinking of Si-containing functional groups, catalyst a4) being different from each of constituents a1) to a3).

Preferably, the at least one catalyst a4) is suitable for crosslinking of Si-containing functional groups being present in constituent b3) of component B), if constituent b3) is present.

Preferably, component A) of the primer coating system comprises the at least one catalyst a4) in an amount in a range of from 0.01 to 2.5 wt.-%, more preferably of from 0.02 to 2.0 wt.-%, even more preferably of from 0.03 to 1.5 wt.-%, still more preferably of from 0.04 to 1.2 wt.-%, yet more preferably of from 0.05 to 1.0 wt.-%, in each case based on the total weight of component A).

Preferably, the at least one catalyst a4) is a phosphorus-containing catalyst and/or a phosphorus-containing and nitrogen-containing catalyst. More than one such as two different catalysts can be used as catalyst a4).

Examples of suitable phosphorus-containing catalysts are substituted phosphonic diesters and diphosphonic diesters, preferably selected from the group consisting of acyclic phosphonic diesters, cyclic phosphonic diesters, acyclic diphosphonic diesters and cyclic diphosphonic diesters. More particularly, however, use as at least one catalyst a4) is made of substituted phosphoric monoesters and phosphoric diesters, preferably selected from the group consisting of acyclic phosphoric diesters and monoesters and cyclic phosphoric diesters and monoesters, which may be in each case amine adducts, e.g., of phosphoric monoesters and diesters.

Examples of such amine adducts are corresponding amine-blocked phosphoric esters, and, of these, more particularly, amine-blocked ethylhexyl phosphates and amine-blocked phenyl phosphates, very preferably amine-blocked bis(2-ethylhexyl) phosphate. Examples of amines with which the phosphoric esters are blocked are, in particular, tertiary amines, examples being bicyclic amines, such as diazabicyclooctane (DABCO), diazabicyclononene (DBN), diazabicycloundecene (DBU), dimethyldodecylamine or triethylamine, for example. Particularly preferred for blocking the phosphoric esters is the use of tertiary amines which ensure high activity of the catalyst under the curing conditions. Certain amine-blocked phosphoric acid catalysts are also available commercially (e.g., Nacure types from King Industries such as Nacure® 4167).

Preferably, the at least one catalyst a4) is selected from phosphorus-containing organic constituents, more preferably from acyclic phosphoric diesters, acyclic phosphoric monoesters, cyclic phosphoric diesters and cyclic phosphoric monoesters, wherein each of the aforementioned phosphoric diesters and monoesters can optionally be present in form of an adduct with at least one amine (i.e., blocked with at least one amine), preferably, at least one tertiary amine, even more preferably, wherein at least two catalysts are present as the at least one catalyst a4), which are both selected from acyclic phosphoric diesters, acyclic phosphoric monoesters, cyclic phosphoric diesters and cyclic phosphoric monoesters, but wherein at least one of these at least two catalysts is present in the form of its amine adduct and the other one of these at least two catalysts is not present as amine adduct (i.e., in an unblocked form).

Preferably, at least 2-ethylhexylacid phosphate is used as at least one catalyst a4), in particular as at least one catalyst a4), which is not present in the form of an amine adduct, i.e., not in any amine blocked form. The term “2-ethylhexylacid phosphate” comprises both monoethylhexyl acid phosphate and diethylhexyl acid phosphate.

Preferably, the amount of the catalyst being present in form of an amine adduct exceeds the amount of the catalyst being present not in form of an amine adduct. Preferably, the relative weight ratio of the catalyst not being present in form of an amine adduct and the catalyst present in form of an amine adduct to each other within component A) is in a range of from 0.1 to 1.0 to 0.9:1.0, more preferably of from 0.2 to 1.0 to 0.8 to 1.0, even more preferably of from 0.3 to 1.0 to 0.7 to 1.0.

Preferably, at least two kinds of catalysts a4) are present, one catalyst being not present in any form of an amine adduct such as 2-ethylhexylacid phosphate, preferably in an amount in a range of from 0.01 to 0.4 wt.-%, and one catalyst being present in form of an amine adduct, preferably in an amount in a range of from 0.05 to 1.0 wt.-%.

Preferably, component A) of the primer coating system comprises the catalyst being present in form of an amine adduct in an amount in a range of from 0.05 to 2.0 wt.-%, more preferably of from 0.06 to 1.8 wt.-%, even more preferably of from 0.07 to 1.6 wt.-%, still more preferably of from 0.08 to 1.4 wt.-%, yet more preferably of from 0.09 to 1.2 wt.-%, particularly preferred of from 0.10 to 1.0 wt.-%, in each case based on the total weight of component A).

Preferably, component A) of the primer coating system comprises the catalyst not being present in form of an amine adduct in an amount in a range of from 0.01 to 1.0 wt.-%, more preferably of from 0.02 to 0.8 wt.-%, even more preferably of from 0.03 to 0.6 wt.-%, still more preferably of from 0.04 to 0.5 wt.-%, yet more preferably of from 0.05 to 0.4 wt.-%, in each case based on the total weight of component A).

Preferably, component A) of the primer coating system further comprises at least one catalyst a5) suitable for crosslinking of NCO-groups, catalyst a5) being different from catalyst a4) and also from each of constituents a1) to a3).

Preferably, the at least one catalyst a5) is suitable for crosslinking of NCO-groups of the constituent b2) of component B).

Preferably, component A) of the primer coating system comprises the at least one catalyst a5) in an amount in a range of from 0.001 to 1.00 wt.-%, more preferably of from 0.002 to 0.80 wt.-%, even more preferably of from 0.003 to 0.60 wt.-%, still more preferably of from 0.004 to 0.40 wt.-%, yet more preferably of from 0.005 to 0.20 wt.-%, most preferably of from 0.007 to 0.15 wt.-%, in each case based on the total weight of component A).

Preferably, catalyst a5) is selected from organometal catalysts, in particular organotin catalysts. Examples of organotin catalysts are DOTL (dioctyltin dilaurate) and DBTL (dibutyltin dilaurate). DOTL is particularly preferred.

### Further Constituents

Component A) of the primer coating system can optionally comprise one or more further constituents such as one or more of constituents a6) to a8), which are different from one another, different from each of constituents a1) to a3) and different from each of optional constituents a4) and a5). Preferably, component A) of the primer coating system comprises at least one, preferably at least two, more preferably at least three, of the constituents a6) to a8).

Preferably, component A) of the primer coating system comprises
at least one epoxy resin as constituent a6), preferably in an amount in a range of from 0.5 to 15.0 wt.-%, more preferably of from 1.0 to 10.0 wt.-%, even more preferably of from 1.5 to 7.5 wt.-%, still more preferably of from 2.0 to 5.5 wt.-%, in each case based on the total weight of component A),
and/or
at least one chlorinated polyolefin as constituent a7), preferably in an amount in a range of from 5.0 to 35 wt.-%, more preferably of from 6.0 to 30.0 wt.-%, even more preferably of from 7.0 to 25.0 wt.-%, still more preferably of from 8.0 to 20 wt.-%, in each case based on the total weight of component A),
and/or
at least one pigment and/or filler as constituent a8), preferably in an amount in a range of from 5.0 to 30 wt.-%, more preferably of from 6.0 to 25.0 wt.-%, even more preferably of from 7.0 to 20.0 wt.-%, still more preferably of from 8.0 to 15 wt.-%, in each case based on the total weight of component A).

The term “pigment” is known to the skilled person, from DIN 55943 (date: October 2001), for example. A “pigment” in the sense of the present invention refers preferably to a constituent in powder or flake form which is substantially, preferably entirely, insoluble in the medium surrounding them, such as in one of the inventively used coating compositions, for example. Pigments are preferably colorants and/or substances which can be used as pigment on account of their magnetic, electrical and/or electromagnetic properties. Pigments differ from “fillers” preferably in their refractive index, which for pigments is 1.7. The term “filler” is known to the skilled person, from DIN 55943 (date: October 2001), for example. Pigments can be inorganic or organic.

Component A) of the primer coating system can optionally comprise one or more further constituents such in addition to or as alternative to the one or more constituents a6) to a8). Component A) may contain one or more commonly used additives depending on the desired application. For example, it may comprise at least one additive selected from the group consisting of reactive diluents, light stabilizers, antioxidants, deaerators, emulsifiers, slip additives, polymerization inhibitors, plasticizers, initiators for free-radical polymerizations, adhesion promoters, flow control agents, film-forming auxiliaries, flame retardants, corrosion inhibitors, siccatives, biocides, thickeners, wetting agents, levelling agents and/or matting agents. They can be used in the known and customary proportions. Preferably, their content, based on the total weight of the coating composition obtained from mixing components A) and B) and optionally C) is 0.01 to 20.0 wt.-%, more preferably 0.05 to 15.0 wt.-%, particularly preferably 0.1 to 10.0% by weight, even more preferably from 0.1 to 7.5% by weight, especially from 0.1 to 5.0% by weight and most preferably from 0.1 to 2.5% by weight, in each case based on the total weight of the coating composition.

In particular, component A) of the primer coating system optionally comprises at least one levelling agent and/or dispersing agent as additive as constituent a9). Preferably, a9) is a (meth)acrylate polymer, which contains at least one kind of ether segment(s), preferably in a side chain, and/or at least one kind of siloxane units, preferably also in a side chain. Preferably, constituent a9) is present in component A) in a range of from 0.10 to 5.0 wt.-%, more preferably of from 0.50 to 4.0 wt.-%, still more preferably of from 0.80 to 3.5 wt.-%, to in each case based on the total weight of component A).

### Component B)

Component B) comprises at least two constituent b2) and optionally also constituent b1), which are different from one another, but may additionally comprise further optional constituents.

Preferably, component B) is free of any condensate a3), i.e., condensate a3) is only present in component A) of the primer coating system.

Preferably, component B) of the primer coating system has a total solids content, which is >40 wt.-%, more preferably >45 wt.-%, even more preferably >50 wt.-%, still more preferably >55 wt.-%, in each based on the total weight of component B). The total solids content of component B) of the primer coating system s preferably in a range of from 45 to 100 wt.-%, more preferably of from 50 to <100 wt.-%, even more preferably of from 55 to <100 wt.-%, based in each case on the total weight of component B). The total solids content, in other words the non-volatile fraction, is determined in accordance with the method described hereinafter.

### Optional Constituent b1)

Optional constituent b1) is at least one organic solvent. Examples of such organic solvents include the ones already mentioned hereinbefore in connection with constituent a1). Component B) may comprise more than one organic solvent b1). The at least one organic solvent b1) may the identical to or different from the at least one organic solvent a1). If more than one organic solvent is used as a1) and/or b1) it may be that a1) and b1) are both partially identical and partially different.

Preferably, the amount of constituent b1) in component B) is in the range of from 5 to 50 wt.-%, more preferably of from 10 to 40 wt.-%, even more preferably of from 15 to 35 wt.-%, based in each case on the total weight of component B).

### Constituent b2)

Constituent b2) is an organic constituent bearing on average two or more NCO-groups. Preferably, constituent b2) bears on average more than two NCO-groups.

Preferably, the at least one organic constituent b2) present in component B) has an aliphatic or cycloaliphatic structure and/or a parent structure that is derived from an aliphatic or cycloaliphatic polyisocyanate by trimerization, dimerization, urethane formation, biuret formation, uretdione formation and/or allophanate formation. Trimers, i.e., isocyanurates, of IPDI (isophorone diisocyanate) and/or HDI (hexamethylene diisocyanate) are particularly preferred.

Suitable aliphatic polyisocyanates are preferably substituted or unsubstituted aliphatic polyisocyanates such as tetramethylene 1,4-diisocyanate, hexamethylene 1,6-diisocyanate, 2,2,4-trimethylhexane 1,6-diisocyanate, ethylene diisocyanate, dodecane 1,12-diisocyanate, and mixtures of the aforementioned polyisocyanates. Suitable polyisocyanate parent structures may be polyisocyanate prepolymers having urethane structural units which are obtained by reaction of polyols with a stoichiometric excess of aforementioned aliphatic polyisocyanates. Particularly preferred polyisocyanate parent structures are hexamethylene diisocyanate and/or its biuret dimer and/or allophanate dimer and/or isocyanurate trimer and/or its uretdione, and also mixtures of the stated polyisocyanate parent structures. Especially preferred polyisocyanate parent structures are hexamethylene diisocyanate and/or its isocyanurate trimer, optionally together with its uretdione.

Suitable cycloaliphatic polyisocyanates are preferably substituted or unsubstituted cycloaliphatic polyisocyanates such as isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate and 4,4′-methylendicyclohexyl diisocyanate and mixtures of the aforementioned polyisocyanates. Suitable polyisocyanate parent structures may be polyisocyanates derived from a cycloaliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may be polyisocyanate prepolymers having urethane structural units which are obtained by reaction of polyols with a stoichiometric excess of aforementioned cycloaliphatic polyisocyanates. Particularly preferred cycloaliphatic polyisocyanates are isophorone diisocyanate and 4,4′-methylenedicyclohexyl diisocyanate and/or the biuret dimers thereof and/or the allophanate dimers thereof and/or the isocyanurate trimers thereof.

Preferably, constituent b2) does not contain any silane modified NCO-groups, i.e., none of its NCO-groups has been preferably reacted with any silane. Preferably, component B) as such does not comprise any NCO-group(s) containing constituent(s) that bear(s) any silane modified NCO-groups.

### Constituent b3)

Optionally, component B) of the primer coating system comprises at least one optional constituent b3). Optional constituent b3) is an organosilane constituent being different from each of constituents b1) and b2) and bearing at least one hydrolyzable group X and preferably additionally at least one non-hydrolyzable organic residue R and/or T. Optional constituent b3) is also different from each of the constituents a1) to a3) of component A). Preferably, constituent b3) is used as adhesion promoter.

Preferably, the at least one organosilane constituent b3) is a monosilane and has at least two, particularly preferably at least three hydrolyzable groups X, and/or is at least one bis(silane), which preferably has at least four, particularly preferably six hydrolyzable groups X.

Preferably, the at least one organosilane b3) is an organosilane of general formula (I) and/or (II)

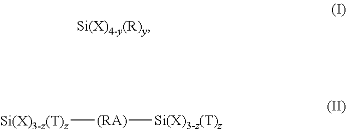

wherein in the case of general formula (I)
X is each independently a hydrolyzable group, preferably each independently selected from O—C₁₋₄ alkyl,
the parameter y is an integer in the range from 1 to 3, but is at least 1, preferably exactly 1, and
R is a non-hydrolyzable organic residue, preferably aliphatic residue, which preferably has 1 to 10 carbon atoms, wherein at least one of residues R optionally comprises at least one functional group,
and wherein in the case of general formula (II)
X represents, in each case independently of one another, a hydrolyzable group and is preferably selected, in each case independently of one another, from O—C₁₋₄-alkyl, RA represents a divalent non-hydrolyzable organic residue, preferably aliphatic residue, which preferably has 1 to 10 carbon atoms, which preferably contains no functional group,
the parameter z is in each case an integer in the range from 0 to 3, preferably in each case 0, and
T is a non-hydrolyzable organic residue, preferably aliphatic residue, which preferably has 1 to 10 carbon atoms, which is different from the residue RA, and which optionally comprises at least one functional group.

Examples of suitable functional groups are in particular thiol groups, amino groups, epoxide groups.

Examples of suitable organosilanes are, e.g., (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane, (3-glycidyloxypropyl)triethoxysilane, bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine and/or bis(4-butyltriethoxysilyl)amine.

### Optional Component C)

Optional component C) is a reducer component and comprises at least one organic solvent c1). Component C) is used for diluting the to-be-prepared coating composition and for this reason comprises at least one organic solvent c1) and preferably consists of the at least one organic solvent c1). Examples of such organic solvents include the ones already mentioned hereinbefore in connection with constituents a1) and b1). Component C) may comprise more than one organic solvent c1). The at least one organic solvent c1) may the identical to or different from the at least one organic solvent a1) and/or b1). If more than one organic solvent is used as a1) and/or b1) and/or c1) it may be that a1) and/or b1) and/or c1) are both partially identical and partially different.

### Primer Coating Composition

The primer coating composition is either
obtainable by mixing at least components A) and B) and optionally C) of the primer coating system with each other (1^{st} alternative)
or is a primer coating composition, which at least comprises constituents (i), (ii) and (iii) and optionally also (iv), which are different from one another (2^{nd} alternative), namely
(i) at least one organic solvent, which preferably corresponds to the at least one organic solvent a), b1) and/or c1) as defined for the inventive primer coating system,
(ii) at least one film-forming polymer, which is self-crosslinking or externally crosslinking, preferably is externally crosslinking, more preferably which corresponds to the at least one polymer a2), which contains functional groups, that are reactive towards NCO-groups, as defined for the inventive primer coating system,
(iii) at least one condensation product, which corresponds to the condensation product a3) as defined for the inventive primer coating system, and
(iv) optionally at least one crosslinking agent at least in case the at least one film-forming polymer (ii) is an externally crosslinking polymer, which crosslinking agent preferably is selected from blocked polyisocyanates, melamine formaldehyde resins and mixtures thereof.

The preparation of the coating composition of the 1^{st} alternative can be carried out using customary and known preparation and mixing methods and mixing units, or using conventional dissolvers and/or stirrers.

All preferred embodiments described above herein in connection with the primer coating system and the preferred embodiments thereof, are also preferred embodiments of the primer coating composition.

Preferably, the primer coating composition is a solventborne, i.e., an organic solvent(s) based, coating composition, preferably due to the presence of constituents a1) and b1) and optionally c1). The term “solventborne” in connection with the coating composition is understood preferably for the purposes of the present invention to mean that the aforementioned organic solvent(s), as solvent and/or as diluent, is/are present as the main constituent(s) of all solvents and/or diluents present therein, preferably in an amount of at least 35 wt.-%, based on the total weight of the coating composition. Thus, preferably, the coating composition is not a waterborne, i.e., not an aqueous, coating composition.

The primer coating composition preferably includes an organic solvent(s) fraction of at most 75 wt.-%, more preferably of at most 70 wt.-%, even more preferably of at most 65 wt.-%, still more preferably of at most 60 wt.-%, based in each case on the total weight of the coating composition. All conventional organic solvents known to those skilled in the art can be used as organic solvents, i.e., as constituents a1) and b1) and optionally c1). The term “organic solvent” is known to those skilled in the art, in particular from Council Directive 1999/13/EC of 11 Mar. 1999. Examples of the organic solvents which can be used have been mentioned hereinbefore in connection with constituents a1) and b1) and c1). Preferably, the primer coating composition includes an organic solvent(s) fraction in a range of from 30 to 70 wt.-%, based on the total weight of the coating composition.

Preferably, the primer coating composition has a total solids content, which is >25 wt.-%, more preferably >30 wt.-%, even more preferably >35 wt.-%, based in each case on the total weight of the coating composition.

The total solids content of the primer coating composition is preferably in a range of from >20 to 60 wt.-%, more preferably of from >25 to 55 wt.-%, even more preferably of from >30 to 50 wt.-%, still more preferably of from >30 to 45 wt.-%, based in each case on the total weight of the coating composition. The total solids content, in other words the non-volatile fraction, is determined in accordance with the method described hereinafter.

Preferably, the primer coating composition is obtainable by mixing components A) and B) in a weight ratio (component A)/component B)) in a range of from 25:1 to 1:1. More preferably, mixing is performed in a weight ratio in the range of from 20:1 to 1.1:1, even more preferably in a weight ratio in the range of from 17.5:1 to 2:1, in particular in a weight ratio in the range of from 15:1 to 3:1.

Preferably, the primer coating composition contains an excess of constituent b2) bearing on average two or more NCO-groups such that upon migration of said constituent into an intermediate coating film, preferably into a basecoat film, applied on top of a primer coating film obtained from the primer coating composition onto a substrate, at least partial curing of the intermediate coating film is achieved, when said intermediate coating film contains at least one preferably polymeric constituent, which contains functional groups that are reactive towards NCO-groups. The term “excess” in this context preferably means a molar or mass excess, more preferably a mass excess.

The term “excess of constituent b2)” preferably means that an amount of 5 to 20 wt.-%, preferably 7.5 to 15 wt.-%, more preferably 10 to 12.5 wt.-% to of constituent b2) originating from component “B”, in each case based on the total weight of constituent b2) originally present in said component B), is still present in the resulting primer coating composition after mixing, which amount is not used for crosslinking with the relevant constituents such as constituent a2) of component A) due to using constituent b) in a super-stoichiometric amount. By this it is possible to also at least partially cure a subsequently to be applied basecoat film via NCO-migration when applied on top of a primer coating film being obtainable from applying the primer coating material composition onto a surface of a substrate.

The inventive primer coating composition according to the 2^{nd} alternative is a 1K- (one-component) coating composition, which does not require mixing of any of its constituents only shortly prior to the application as in case of the inventive primer coating system. Preferably, the 1K-primer coating composition of the 2^{nd} alternative does not contain any free polyisocyanates, i.e., any constituents, which bear unblocked NCO-groups.

The 1K-primer coating composition of the 2^{nd} alternative contains at least one organic solvent as constituent (i). The same solvents as defined hereinbefore for constituents a1), b1) and c1) can also be used as constituent (i).

The 1K-primer coating composition of the 2^{nd} alternative may contain any of the further constituents defined hereinbefore to be present as constituents in component A) of the primer coating system including, e.g., any of constituents a4) to a9). All preferred embodiments described above herein in connection with any of these constituents present in the primer coating system are also preferred embodiments when present in the 1K-primer coating composition of the 2^{nd} alternative.

The 1K-primer coating composition of the 2^{nd} alternative contains at least one condensation product as constituent (iii), which corresponds to the condensation product a3) as defined hereinbefore for the inventive primer coating system. All preferred embodiments described above herein in connection with the condensation product a3) present in the primer coating system are also preferred embodiments of the condensation product a3) present in the 1K-primer coating composition of the 2^{nd} alternative.

Preferably, the at least one condensation product a3) is present in the primer coating composition in an amount in a range of from 1.0 to 25.0 wt.-%, more preferably of from 2.0 to 20.0 wt.-%, even more preferably of from 3.0 to 17.5 wt.-%, yet more preferably of from 4.0 to 15.0 wt.-%, still more preferably of from 5.0 to 14.0 wt.-%, even more preferably of from 6.0 to 13.0 wt.-%, most preferably of from 7.0 to 12.0 wt.-%, based on the total weight of the primer coating composition.

The 1K-primer coating composition of the 2^{nd} alternative contains at least one film-forming polymer, which is self-crosslinking or externally crosslinking, preferably is externally crosslinking, more preferably which corresponds to the at least one polymer a2), which contains functional groups, that are reactive towards NCO-groups, as defined for the inventive primer coating system. It optionally further comprises at least one crosslinking agent at least in case the at least one film-forming polymer (ii) is an externally crosslinking polymer. The at least one crosslinking agent preferably is selected from blocked polyisocyanates, melamine formaldehyde resins and mixtures thereof. All preferred embodiments described above herein in connection with polymer a2) present in the primer coating system are also preferred embodiments of the polymer constituent (ii) present in the 1K-primer coating composition of the 2^{nd} alternative.

### Use of the Primer Coating Composition

A further subject-matter of the present invention is a use of the inventive primer coating composition for improving water and/or moisture resistance of a cured primer coating film obtainable therefrom and/or of a cured multilayer coating system containing at least one cured primer coating film, said cured primer coating film being obtainable from said primer coating composition. The improvement can be in particular attributed to the presence of constituent a3).

All preferred embodiments described above herein in connection with the primer coating system and the primer coating composition and in each case the preferred embodiments thereof, are also preferred embodiments of the aforementioned use.

### Method of Coating a Substrate

A further subject-matter of the present invention is a method of coating a substrate comprising at least a step 1) and optional step (1a), namely
1) applying the inventive primer coating composition at least partially to at least one surface of an optionally pre-coated substrate and forming a primer coating film on said surface,
1a) and optionally at least one further step 1a) of curing the at least one primer coating film obtained after step 1) to obtain at least one cured primer coating layer onto said surface.

All preferred embodiments described above herein in connection with the primer coating system, the primer coating composition and the aforementioned use and in each case the preferred embodiments thereof, are also preferred embodiments of the aforementioned method.

Preferably, step 1) is performed via spray application.

The primer coating film formed on the optionally pre-coated substrate by performing step 1) is at this stage an uncured coating film. The term “primer” is known to a person skilled in the art. A primer typically is applied after the substrate has been provided with a cured electrodeposition coating layer in case of metallic substrates. In this case, the cured electrodeposition coating film is present underneath and preferably adjacent to the primer coating film. This is an example of a pre-coated substrate. In case of non-metallic substrates such as plastic substrates including fiber reinforced plastic substrates the primer coating film typically represents the first coating film applied onto their surfaces.

Preferably, step 1a) is performed at a temperature in a range of from 30 to 180° C., more preferably in a range of from 35 to 170° C., even more preferably in a range of from 40 to 140° C., still more preferably in a range of from 40 to 130° C., in each case preferably for a period of 5 to 45 minutes, more preferably for a period of 10 to 40 minutes, in particular for a period of 12.5 to 35 minutes, most preferably for a period of 15 to 30 minutes. Most preferably, in particular, when a plastic substrate or fiber reinforced plastic substrate is used, step 1a) is performed at a temperature not exceeding 80° C., preferably not exceeding 70° C., more preferably not exceeding 60° C. even more preferably not exceeding 55° C. Prior to step 1a) the primer coating film may optionally be flashed-off, preferably for a period of 1 to 20 minutes, more preferably for a period of 1.5 to 15 minutes, still more preferably for a period of 2 to 12 minutes, yet more preferably for a period of 5 to 11 minutes, most preferably for a period of 8 to 10 minutes. Preferably, the flashing-off is performed at a temperature not exceeding 40° C., more preferably at a temperature in the range of from 18 to 30° C.

The term “flashing off” in the sense of the present invention means a drying, wherein at least some of the solvents and/or water are evaporated from the coating film (i.e., from the primer coating layer being formed), before any curing is carried out. No curing is performed by the flashing-off.

Preferably, the cured primer film (primer layer L1) obtained after step 1a) has a dry film thickness in a range of from 10 to 35 μm.

The method is particularly suitable for the coating of automotive vehicle bodies or parts thereof including respective metallic substrates, but also plastic substrates such as polymeric substrates and fiber reinforced plastic substrates. Consequently, the preferred substrates are automotive vehicle bodies or parts thereof.

Suitable as metallic substrates used in accordance with the invention are all substrates used customarily and known to the skilled person. The substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production. A metallic substrate may have been pretreated with at least one metal phosphate such as zinc phosphate and/or pretreated with at least one an oxalate. A pretreatment of this kind by means of phosphating or oxalating, which takes place normally after the substrate has been cleaned and before the substrate is electrodeposition-coated, is in particular a pretreatment step that is customary in the automobile industry. The metallic substrate may further comprise a cured electrodeposition coating layer as pre-coat.

Preferably, thermoplastic polymers are used as plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

Further, and most preferred, fiber reinforced plastic substrates are used. Glass and/or carbon fibers can be in particular used for reinforcement, most preferably carbon fibers. An examples of a suitable carbon fiber reinforced plastic substrate is a carbon fiber reinforced polyamide substrate.

### Coated Substrate

A further subject-matter of the present invention is a coated substrate, which is obtainable by said method.

All preferred embodiments described above herein in connection with the primer coating system, the primer coating composition, the aforementioned use and method and in each case the preferred embodiments thereof, are also preferred embodiments of the coated substrate.

### Method of Preparing a Multilayer Coating System

A further subject-matter of the present invention is a method of preparing a multilayer coating system on at least one surface of an optionally pre-coated substrate comprising at least steps 1) to 3) and optionally 4), namely
1) applying a first coating composition at least partially to at least one surface of an optionally pre-coated substrate and forming a first coating film on said surface, wherein the first coating composition is said primer coating composition,
2) applying at least one basecoat composition as at least one second coating composition to the first coating film present on the substrate obtained after step 1), preferably prior to curing the first coating film, and forming a second coating film, which is preferably adjacent to the first coating film, and
3) applying a topcoat composition, preferably a clearcoat composition, as third coating composition to the second coating film present on the substrate obtained after step 2), preferably prior to curing the second coating film and forming a third coating film, which is preferably adjacent to the second coating film and which preferably is the outermost coating film of the formed multilayer coating system, and
4) optionally jointly curing the first, second and third coating films to obtain a multilayer coating system comprising cured first, second, and third coating layers.

All preferred embodiments described above herein in connection with the primer coating system, the primer coating composition, the aforementioned use and method, and the coated substrate and in each case the preferred embodiments thereof, are also preferred embodiments of the method for preparing a multilayer coating system.

The method comprises at least steps (1), (2), (3) and optionally (4). The method may, however, comprise further additional optional steps.

Preferably, each of step 1) to 3) is performed via a spray application.

The first, second, and third coating film formed on the optionally pre-coated substrate by performing steps 1), 2), and 3) are at this stage preferably each an uncured coating film. Thus, preferably both the first and the second and the third coating compositions are applied wet-on-wet.

Preferably, the inventive method further comprises a step 1 b), which is carried out after step 1) and before step 2). In said step 1 b) the first coating film obtained after step 1) is flashed-off before applying the second coating composition in step 2) preferably for a period of 1 to 20 minutes, more preferably for a period of 1.5 to 15 minutes, still more preferably for a period of 2 to 12 minutes, yet more preferably for a period of 5 to 11 minutes, most preferably for a period of 8 to 10 minutes. Preferably, step 1b) is performed at a temperature not exceeding 40° C., more preferably at a temperature in the range of from 18 to 30° C.

The second coating film is a basecoat film. Thus, the second coating composition is a basecoat composition. The term “basecoat” is known to a person skilled in the art and, for example, defined in Römpp Lexikon, paints and printing inks, Georg Thieme Verlag, 1998, 10th edition, page 57. A basecoat is therefore in particular used in automotive painting and general industrial paint coloring in order to give a coloring and/or an optical effect by using the basecoat as an intermediate coating composition. This is generally applied to a metal or plastic substrate, in each case being optionally pre-coated. In order to protect a basecoat film in particular against environmental influences, at least one additional topcoat, preferably, clearcoat film is applied to it. The term “clear coat”, “clearcoat” or “clear coating” is also known to a person skilled in the art and represent a transparent outermost layer of a multilayer coating structure applied to a substrate.

Preferably, the method further comprises a step 2a), which is carried out after step 2) and before step 3). In said step 2a) the second coating film obtained after step 2) is flashed-off before applying the third coating composition in step 3), preferably for a period of 1 to 20 minutes, more preferably for a period of 1.5 to 15 minutes, still more preferably for a period of 2 to 12 minutes, yet more preferably for a period of 5 to 11 minutes, most preferably for a period of 8 to 10 minutes. Preferably, step 2a) is performed at a temperature not exceeding 40° C., more preferably at a temperature in the range of from 18 to 30° C.

Preferably, the method further comprises a step 3a), which is carried out after step 3) and before step 4). In said step 3a) the third coating film obtained after step 3) is flashed-off before performing curing step 4), preferably for a period of 1 to 20 minutes, more preferably for a period of 3 to 15 minutes, in particular for a period of 7 to 12 minutes. Preferably, step 3a) is performed at a temperature not exceeding 40° C., more preferably at a temperature in the range of from 18 to 30° C.

In step 4) first, second and third coating films are jointly cured, i.e., are cured together simultaneously. The cured third coating film preferably represents the outermost layer of the formed multilayer coating system obtained after step 4).

Each resulting cured coating film represents a coating layer. Thus, after performing step 4) a first, second and third coating layer is formed on the optionally pre-coated substrate, with the third layer being preferably the outermost layer of the formed multilayer coating system. A first layer L1 is obtainable from the first coating film, a 20 second layer L2 from the second coating film and a third layer L3 from the third coating film.

Preferably, step 4) is performed at a temperature in a range of from 30 to 180° C., more preferably in a range of from 35 to 170° C., even more preferably in a range of from 40 to 140° C., still more preferably in a range of from 40 to 130° C., in each case preferably for a period of 5 to 45 minutes, more preferably for a period of 10 to 40 minutes, in particular for a period of 12.5 to 35 minutes, most preferably for a period of 15 to 30 minutes. Most preferably, in particular, when a plastic substrate or fiber reinforced plastic substrate is used, step 4) is performed at a temperature not exceeding 80° C., preferably not exceeding 70° C., more preferably not exceeding 60° C., even more preferably not exceeding 55° C. Temperature is in each case substrate temperature, which is preferably measured with a thermocouple.

Preferably, the cured primer film (layer L1) obtained after having performed step 4) has a dry film thickness in a range of from 10 to 35 μm. Preferably, the cured basecoat film (layer L2) obtained after having performed step 4) has a dry film thickness in a range of from 12 to 35 μm. Preferably, the cured topcoat, in particular clearcoat, film (layer L3) obtained after having performed step 4) has a dry film thickness in a range of from 30 to 60 μm.

### Basecoat and Topcoat Compositions

Any type of basecoat composition can be used in step 2), e.g., a 1K- or 2K-basecoat composition, preferably a 1K-composition, which may be solventborne or aqueous and may contain coloring and/or effect pigments. Preferably, the basecoat composition comprises at least one film-forming binder, preferably at least one polymer, more preferably at least one polymer, which has functional groups that are reactive towards NCO-groups. Optionally, the basecoat composition may include at least one crosslinking agent, preferably selected from melamine formaldehyde resins and/or preferably blocked polyisocyanates, in particular in case the at least film-forming binder is an externally crosslinking polymer.

Any type of topcoat, preferably clearcoat, composition can be used in step 3), e.g., a 1K- or 2K-clearcoat composition, preferably a 2K-clearcoat composition, which may be solventborne or aqueous, but preferably is solventborne.

Preferably, a 2K-clearcoat composition is used, more preferably, a respective clearcoat composition, which is obtainable from a suitable clearcoat coating system comprising at least two components D) and E) and optionally at least one further component F), said components being different from one another and being separate from each other. Preferably, component D) comprises at least constituents d1) to d4), which are different from one another, namely at least one organic solvent d1), at least one OH-functional (meth)acrylic polymer d2) and at least one OH-functional (meth)acrylic polymer d3) having a glass transition temperature (T_{g}) being lower than the glass transition temperature (T_{g}) of the at least one OH-functional (meth)acrylic polymer d2), wherein the amount of constituent d2) in component D) exceeds the amount of constituent d3), and at least one catalyst d4) suitable for crosslinking of NCO-groups, which is selected from organotin catalysts and which is identical to or different from catalyst a3). Preferably, component E) comprises at least two constituents e1) and e2), which are different from one another, namely at least one organic solvent e1), and at least one organic constituent e2) bearing on average two or more NCO-groups, wherein at least a part of these NCO-groups has been reacted with at least one organosilane prior to incorporation of constituent e2) into component E), and wherein optional component F) is a reducer component and comprises at least one organic solvent f1). Preferably, both components D) and E) and optionally F) of the clear coating system are transparent, i.e., clear. Preferably, of course, also the clearcoat composition obtainable therefrom is transparent, i.e., clear. In particular, none of the component D) and E) and optionally F) of the coating system contains any pigments and/or fillers, in particular any color and/or effect imparting pigments and/or fillers. The same applies, of course, also preferably, to the clearcoat composition.

### Constituent d1)

Constituent d1) is at least one organic solvent. Examples of such organic solvents include the ones already mentioned hereinbefore in connection with constituent a1) and b1) and c1). Component D) may comprise more than one organic solvents d1). The at least one organic solvent d1) may the identical to or different from the at least one organic solvent a1) and/or b1) and/or c1). If more than one organic solvent is used as a1) and/or b1) and/or c1) and/or d1) it may be that a1) and b1) and/or c1) and/or d1) are both partially identical and partially different.

### Constituents d2) and d3)

Constituent d2) is at least one OH-functional (meth)acrylic polymer. Constituent d3) is also at least one OH-functional (meth)acrylic polymer, but is different from d2). The at least one OH-functional (meth)acrylic polymer d3) has a glass transition temperature (T_{g}) which is lower than the glass transition temperature (T_{g}) of the at least one OH-functional (meth)acrylic polymer d2). The amount of constituent d2) in component D) exceeds the amount of constituent d3), i.e., the (meth)acrylic polymer d2) having a higher T_{g} (higher than (meth)acrylic polymer d3)) is present in component D) in a higher amount than (meth)acrylic polymer d3). T_{g} is measured according to the method disclosed in the ‘method’ section.

Preferably, the at least one OH-functional (meth)acrylic polymer d2) present in component D) of the clearcoat system has a glass transition temperature (T_{g}) being in a range of from +10° C. to +75° C., preferably of from +15° C. to +70° C., more preferably of from +20° C. to +65° C., still more preferably of from +25° C. to +60° C., even more preferably of from +30° C. to +55° C., most preferably of from +35° C. or +40° C. to +50° C. Preferably, the at least one OH-functional (meth)acrylic polymer d3) present in component D) of the clearcoat system has a glass transition temperature (T_{g}) being in a range of from +10° C. to +75° C., preferably of from +15° C. to +70° C., more preferably of from −50° C. to 0° C., still more preferably of from −45° C. to 0° C., even more preferably of from −40° C. to 0° C., yet more preferably of from −35° C. or −30° C. to −5° C., most preferably of from −25° C. or −5° C.

The OH-functional (meth)acrylic polymer d2) and d3) preferably each comprise on average two or more OH-groups. Preferably, each of OH-functional (meth)acrylic polymers d2) and d3) has an OH number of 30 to 400 mg KOH/g, more particularly between 100 and 300 KOH/g. Preferably, each of constituents d2) and d3) have a weight average molecular weight MW, measured by means of gel permeation chromatography (GPC) against a polystyrene standard, preferably between 800 and 100 000 g/mol, more particularly between 1000 and 75 000 g/mol.

The term (meth)acrylic polymer includes both homopolymers and copolymers in each case, but preferably means copolymers.

The term “(meth)acryl” or “(meth) acrylate” or (meth)acrylic” in the context of the present invention in each case comprises the meanings “methacryl” and/or “acryl” “methacrylic” and/or “acrylic” or “methacrylate” and/or “acrylate”. Therefore, a “(meth)acrylic copolymer” in general may be formed from only “acrylic monomers”, only “methacrylic monomers” or “acrylic and methacrylic monomers”. However, polymerizable monomers other than acrylic and/or methacrylic monomers as, e.g., styrene and the like may also be contained in a “(meth)acrylic copolymer”. In other words, a (meth)acrylic polymer may consist of only acrylic and/or methacrylic monomer units but does not have to. The notation “(meth)acrylate polymer or copolymer” or “(meth)acrylic polymer or copolymer” is intended to mean that the polymer/copolymer (polymer skeleton/backbone) is formed predominantly, i.e. preferably more than 50% or more than 75% of the monomer units used, from monomers having a (meth)acrylate group. In the preparation of a (meth)acrylic copolymer, preferably more than 50% or 75% of the monomers thus have a (meth)acrylate group. However, the use of further monomers as comonomers such as copolymerizable vinyl monomers, e.g., styrene, for its preparation is not excluded.

For introduction of OH-functionality, hydroxyl-containing monomers can be used, which include hydroxy alkyl esters of acrylic or methacrylic acid. Non-limiting examples of hydroxyl-functional monomers include hydroxyethyl(meth)acrylate, hydroxypropyl(meth)acrylates, hydroxybutyl-(meth)acrylates, hydroxyhexyl(meth)acrylates, propylene glycol mono(meth)acrylate, 2,3-dihydroxypropyl(meth)acrylate, pentaerythritol mono(meth)acrylate, polypropylene glycol mono(meth)acrylates, polyethylene glycol mono(meth)acrylates, reaction products of these with epsilon-caprolactone, and other hydroxyalkyl-(meth)acrylates having branched or linear alkyl groups of up to about 10 carbons, and mixtures of these, where the term “(meth)acrylate” indicates either or both of the methacrylate and acrylate esters. Generally, at least about 5% by weight hydroxyl-functional monomer is preferably included in the polymer. Hydroxyl groups on a vinyl polymer such as an acrylic polymer can be generated by other means, such as, for example, the ring opening of a glycidyl group, for example from copolymerized glycidyl methacrylate, by an organic acid or an amine.

Hydroxyl functionality may also be introduced through thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-proanediol, 4-mercapto-1-butanol, and combinations of these. Any of these methods may be used to prepare a useful hydroxyl-functional (meth)acrylic polymer.

Examples of suitable comonomers that may be used include, without limitation, α,β-ethylenically unsaturated monocarboxylic acids containing 3 to 5 carbon atoms such as acrylic, methacrylic, and crotonic acids and the alkyl and cycloalkyl esters, nitriles, and amides of acrylic acid, methacrylic acid, and crotonic acid; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic alcohols containing 1 to 20 carbon atoms, such as methyl, ethyl, propyl, isopropyl, n-butyl, isobutyl, tert-butyl, hexyl, 2-ethylhexyl, dodecyl, 3,3,5-trimethylhexyl, stearyl, lauryl, cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, a-methyl styrene, vinyl toluene, 2-vinyl pyrrolidone, and p-tert-butylstyrene.

The (meth)acrylic polymer may be prepared using conventional techniques, such as by heating the monomers in the presence of a polymerization initiating agent and optionally a chain transfer agent. The polymerization may be carried out in solution, for example. Typical initiators are organic peroxides such as dialkyl peroxides such as di-t-butyl peroxide, peroxyesters such as t-butyl peroxy 2-ethylhexanoate, and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol and the other thiol alcohols already mentioned, and dimeric alpha-methyl styrene.

The polymerization reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes. Further details of addition polymerization generally and of polymerization of mixtures including (meth)acrylate monomers is readily available in the polymer art. The solvent or solvent mixture is generally heated to the reaction temperature and the monomers and initiator(s) are added at a controlled rate over a period of time, usually between 2 and 6 hours. A chain transfer agent or additional solvent may be fed in also at a controlled rate during this time. The temperature of the mixture is then maintained for a period of time to complete the reaction. Optionally, additional initiator may be added to ensure complete conversion.

Constituent d2) is preferably present in the component D) in an amount in the range of from 5.0 wt.-% to 85.0 wt.-%, based on the total weight of component (D). More preferably, constituent d2) is present in component D) in an amount in the range of from 10.0 wt.-% to 80.0 wt.-%, yet more preferably of from 15.0 wt.-% to 75.0 wt.-%, in each case based on the total weight of component D).

Constituent d3) is preferably present in the component D) in an amount in the range of from 5.0 wt.-% to 85.0 wt.-%, based on the total weight of component (D). More preferably, constituent d3) is present in component D) in an amount in the range of from 10.0 wt.-% to 80.0 wt.-%, yet more preferably of from 15.0 wt.-% to 75.0 wt.-%, in each case based on the total weight of component D).

### Constituent d4)

Constituent d4) is at least one catalyst d4), which is suitable for crosslinking of NCO-groups, and which is selected from organotin catalysts. Catalyst d4) may be identical to or different from catalyst a5). Preferably, catalysts d4) and a5) are identical.

Component D) may comprise at least one further organometal catalyst besides catalyst d4) such as, e.g., organobismuth catalysts. However, preferably, if such at least one further organometal catalyst like an organobismuth catalyst is additionally present in component D), its amount is less than the amount of catalyst d4). More preferably, however, component D) does not comprise any other organometal catalysts besides catalyst d4) and in particular does not comprise any organobismuth catalysts.

Preferably, the at least one catalyst d4) suitable for crosslinking of NCO-groups, in particular of constituent e2) of component E), is present in component D) of the clearcoat system in an amount in a range of from 0.001 to 3.00 wt.-%, preferably of from 0.01 to 2.50 wt.-%, more preferably of from 0.05 to 2.00 wt.-%, still more preferably of from 0.10 to 1.50 wt.-%, yet more preferably of from 0.20 to 1.25 wt.-%, most preferably of from 0.30 to 1.00 wt.-%, based on the total weight of component D). Catalyst d4) is selected from organotin catalysts. Examples of organotin catalysts are DOTL (dioctyltin dilaurate) and DBTL (dibutyltin dilaurate). DOTL is particularly preferred.

### Optional Constituent d5)

Preferably, component D) of the clearcoat system further comprises at least one catalyst d5), which is preferably suitable for crosslinking of Si-containing functional groups, catalyst d5) being different from each of constituents d1) to d4). Catalyst d5) may be identical to or different from catalyst a4).

Preferably, the at least one catalyst d5) is suitable for crosslinking of Si-containing functional groups being present in constituent e2) of component E).

Preferably, component D) of the clearcoat system comprises the at least one catalyst d5) in an amount in a range of from 0.01 to 6.00 wt.-%, preferably of from 0.10 to 5.50 wt.-%, more preferably of from 0.40 to 5.00 wt.-%, still more preferably of from 0.70 to 4.50 wt.-%, yet more preferably of from 1.00 to 4.00 wt.-%, most preferably of from 1.10 to 3.75 wt.-%, based on the total weight of component D).

Preferably, the at least one catalyst d5) is a phosphorus-containing catalyst and/or a phosphorus-containing and nitrogen-containing catalyst. More than one such as two different catalysts can be used as catalyst d5).

Examples of suitable phosphorus-containing catalysts are substituted phosphonic diesters and diphosphonic diesters, preferably selected from the group consisting of acyclic phosphonic diesters, cyclic phosphonic diesters, acyclic diphosphonic diesters and cyclic diphosphonic diesters. More particularly, however, use as at least one catalyst d5) is made of substituted phosphoric monoesters and phosphoric diesters, preferably selected from the group consisting of acyclic phosphoric diesters and monoesters and cyclic phosphoric diesters and monoesters, which may be in each case amine adducts, e.g., of phosphoric monoesters and diesters.

Examples of such amine adducts are corresponding amine-blocked phosphoric esters, and, of these, more particularly, amine-blocked ethylhexyl phosphates and amine-blocked phenyl phosphates, very preferably amine-blocked bis(2-ethylhexyl) phosphate. Examples of amines with which the phosphoric esters are blocked are, in particular, tertiary amines, examples being bicyclic amines, such as diazabicyclooctane (DABCO), diazabicyclononene (DBN), diazabicycloundecene (DBU), dimethyldodecylamine or triethylamine, for example. Particularly preferred for blocking the phosphoric esters is the use of tertiary amines which ensure high activity of the catalyst under the curing conditions. Certain amine-blocked phosphoric acid catalysts are also available commercially (e.g., Nacure types from King Industries such as Nacure® 4167).

Preferably, the at least one catalyst d5) is selected from phosphorus-containing organic constituents, more preferably from acyclic phosphoric diesters, acyclic phosphoric monoesters, cyclic phosphoric diesters and cyclic phosphoric monoesters, wherein each of the aforementioned phosphoric diesters and monoesters can optionally be present in form of an adduct with at least one amine (i.e., blocked with at least one amine), preferably, at least one tertiary amine, even more preferably, wherein at least two catalysts are present as the at least one catalyst d5), which are both selected from acyclic phosphoric diesters, acyclic phosphoric monoesters, cyclic phosphoric diesters and cyclic phosphoric monoesters, but wherein at least one of these at least two catalysts is present in the form of its amine adduct and the other one of these at least two catalysts is not present as amine adduct (i.e., in an unblocked form).

Preferably, at least two kinds of catalysts d5) are present, one catalyst being not present in any form of an amine adduct such as 2-ethylhexylacid phosphate, preferably in an amount in a range of from 0.05 to 3.5 wt.-%, more preferably of from 0.10 to 3.0 wt.-%, still more preferably of from 0.50 to 2.0 wt.-% or to 1.5 wt.-%, and one catalyst being present in form of an amine adduct, preferably in an amount in a range of from 1.0 to 4.0 wt.-%, more preferably of from 1.0 to 3.0 wt.-%. Preferably, the amount of the catalyst being present in form of an amine adduct exceeds the amount of the catalyst being present not in form of an amine adduct.

Preferably, at least 2-ethylhexylacid phosphate is used as at least one catalyst d5), in particular as at least one catalyst d5), which is not present in the form of an amine adduct, i.e., not in any amine blocked form. The term “2-ethylhexylacid phosphate” comprises both monoethylhexyl acid phosphate and diethylhexyl acid phosphate.

### Further Constituents

Component D) can optionally comprise one or more further constituents. Component D) may contain one or more commonly used additives depending on the desired application. For example, it may comprise at least one additive selected from the group consisting of reactive diluents, light stabilizers, antioxidants, deaerators, emulsifiers, slip additives, polymerization inhibitors, plasticizers, initiators for free-radical polymerizations, adhesion promoters, flow control agents, film-forming auxiliaries, flame retardants, corrosion inhibitors, siccatives, biocides, thickeners, wetting agents, levelling agents and/or matting agents. They can be used in the known and customary proportions. Preferably, their content, based on the total weight of the coating composition obtained from mixing components D) and E) and optionally F) is 0.01 to 20.0 wt.-%, more preferably 0.05 to 15.0 wt.-%, particularly preferably 0.1 to 10.0% by weight, even more preferably from 0.1 to 7.5% by weight, especially from 0.1 to 5.0% by weight and most preferably from 0.1 to 2.5% by weight, in each case based on the total weight of the coating composition.

Component D) may contain further one or more further (meth)acrylic polymer being different from both d2) and d3), which may be OH-functional as well but do not necessarily have to. Component D) may comprise one or more further film forming polymers suitable as binder constituent such as polyesters and/or polyurethanes. Suitable polyesters are described for example in EP-A-0 994 117 and EP-A-1 273 640. Polyurethane polyols are prepared preferably by reaction of polyester polyol prepolymers with suitable di- and/or polyisocyanates and are described for example in EP-A-1 273 640.

### Component E)

Component E) comprises at least two constituents e1) and e2), which are different from one another, but may additionally comprise further optional constituents. Preferably, component E) of the clearcoat system has a total solids content, which is >40 wt.-%, more preferably >45 wt.-%, even more preferably >50 wt.-%, still more preferably >55 wt.-%, in each based on the total weight of component E). The total solids content of component E) of the clearcoat system is preferably in a range of from 45 to 100 wt.-%, more preferably of from 50 to <100 wt.-%, even more preferably of from 55 to <100 wt.-%, based in each case on the total weight of component E). The total solids content, in other words the non-volatile fraction, is determined in accordance with the method described hereinafter.

### Constituent e1)

Constituent e1) is at least one organic solvent. Examples of such organic solvents include the ones already mentioned hereinbefore in connection with constituent a1) and b1) and c1) and d1. Component E) may comprise more than one organic solvents e1). The at least one organic solvent e1) may the identical to or different from the at least one organic solvent a1) and/or b1) and/or c1) and/or d1). If more than one organic solvent is used as a1) and/or b1) and/or c1) and/or d1) and/or e1) it may be that a1) and b1) and/or c1) and/or d1) and/or e1) are both partially identical and partially different.

### Constituent e2)

Constituent e2) is an organic constituent bearing on average two or more NCO-groups, wherein at least a part of these NCO-groups has been reacted with at least one organosilane prior to incorporation of constituent e2) into component E).

Examples of constituents e2) are, e.g., disclosed in WO 2009/077181 A1, WO 2010/139375 A1, WO 2010/063332 A1, WO 2014/086530 A1 and WO 2014/086529 A1.

Preferably, the at least one constituent e2) of component E) of the clearcoat system bears at least one structural unit of the formula (I)

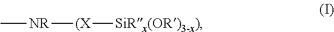

and/or, preferably and, at least one structural unit of the formula (II)

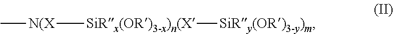

wherein:
   R=hydrogen, alkyl, cycloalkyl, aryl or aralkyl, it being possible for the carbon chain to be interrupted by nonadjacent oxygen, sulfur or NR^{a} groups, where R^{a}=alkyl, cycloalkyl, aryl or aralkyl,
   each R′=independently of one another hydrogen, alkyl or cycloalkyl, it being possible for the carbon chain to be interrupted by nonadjacent oxygen, sulfur or NR^{a} groups, preferably wherein each R′=ethyl and/or methyl,
   each X,X′=independently of one another linear and/or branched alkylene or cycloalkylene radical having 1 to 20 carbon atoms, preferably wherein
   each X,X′=alkylene radical having 1 to 4 carbon atoms,
   each R″=independently of one another alkyl, cycloalkyl, aryl or aralkyl, it being possible for the carbon chain to be interrupted by nonadjacent oxygen, sulfur or NR^{a} groups, preferably wherein each R″=alkyl radical, more particularly having 1 to 6 C atoms,
   n=parameter of 0 to 2, m=parameter of 0 to 2, m+n=2, and x, y=parameter of 0 to 2.

The respective preferred alkoxy radicals (OR′) may be identical or different, but what is decisive for the structure of the radicals is the extent to which they influence the reactivity of the hydrolysable silane groups. Preferably R′ is an alkyl radical, more particularly having 1 to 6 carbon atoms. Particularly preferred are radicals R′ which increase the reactivity of the silane groups, i.e. represent good leaving groups. Accordingly, a methoxy radical is preferred over an ethoxy radical, which in turn is preferred over a propoxy radical. With particular preference, therefore, R′=ethyl and/or methyl, more particularly methyl. The reactivity of organofunctional silanes may also be influenced considerably, furthermore, by the lengths of the spacers X, X′ between silane functionality and organic functional group which serves for reaction with the constituent to be modified. Examples thereof that may be mentioned include the “alpha” silanes, which are obtainable from the company Wacker, and in which there is a methylene group, instead of the propylene group present in the case of “gamma” silanes, between Si atom and functional group.

In constituent e2) preferably, between 10 and 80 mol-%, preferably between 15 and 70 mol-%, more preferably between 20 and 50 mol-% and still more preferably between 25 and 40 mol-% of the isocyanate groups originally present have undergone reaction with the at least one organosilane, preferably to form structural units (I) and/or (II), more preferably to form structural units (I) and (II).

Moreover, preference is given to constituent e2), in which the total amount of structural units (I) is between 3 and 90 mole-%, more preferably between 5 and 70 mole-%, based in each case on the entirety of the structural units (I) plus (II), and the total amount of structural units (II) is between 97 and 10 mole-%, more preferably between 95 and 30 mole-%, based in each case on the entirety of the structural units (I) plus (II).

The at least one organic constituent e2) bearing on average two or more NCO-groups, which serves—before reaction with at the least one silane—as the parent structure for the constituent e2) represent at this stage before reaction with the at least one silane a di- and/or polyisocyanate. Preferably, said at least one di- and/or polyisocyanate is an aromatic, aliphatic, cycloaliphatic and/or heterocyclic di- and/or polyisocyanate, in particular aliphatic and acylic.

The at least one organic constituent e2) preferably has a cycloaliphatic parent structure and/or a parent structure that is derived from a cycloaliphatic polyisocyanate by trimerization, dimerization, urethane formation, biuret formation, uretdione formation and/or allophanate formation, wherein constituent e2) has at least one structural unit of the formula (I) and/or (II). Alternatively or additionally, the at least one organic constituent e2) preferably has an acyclic aliphatic parent structure and/or a parent structure that is derived from an acyclic aliphatic polyisocyanate by trimerization, dimerization, urethane formation, biuret formation, uretdione formation and/or allophanate formation, wherein constituent e2) has at least one structural unit of the formula (I) and/or (II).

Most preferably, the at least one organic constituent e2) has an acyclic aliphatic parent structure and/or a parent structure that is derived from an acyclic aliphatic polyisocyanate by trimerization, dimerization, urethane formation, biuret formation, uretdione formation and/or allophanate formation, wherein constituent e2) has at least one structural unit of the formula (I) and/or (II). Trimers, i.e., isocyanurates, are particularly preferred.

The acyclic aliphatic polyisocyanates serving as parent structures are preferably substituted or unsubstituted aliphatic polyisocyanates that are known per se. Examples are tetramethylene 1,4-diisocyanate, hexamethylene 1,6-diisocyanate, 2,2,4-trimethylhexane 1,6-diisocyanate, ethylene diisocyanate, dodecane 1,12-diisocyanate, and mixtures of the aforementioned polyisocyanates.

Additionally preferred polyisocyanate parent structures are the polyisocyanates derived from such an acyclic aliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may also be polyisocyanate prepolymers having urethane structural units which are obtained by reaction of polyols with a stoichiometric excess of aforementioned acyclic aliphatic polyisocyanates. Polyisocyanate prepolymers of this kind are described for example in U.S. Pat. No. 4,598,131. Particularly preferred polyisocyanate parent structures are hexamethylene diisocyanate and/or its biuret dimer and/or allophanate dimer and/or isocyanurate trimer and/or its uretdione, and also mixtures of the stated polyisocyanate parent structures. Especially preferred polyisocyanate parent structures are hexamethylene diisocyanate and/or its isocyanurate trimer, optionally together with its uretdione.

The cycloaliphatic polyisocyanates used as parent structures are preferably substituted or unsubstituted cycloaliphatic polyisocyanates which are known per se. Examples of preferred polyisocyanates are isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylendicyclohexyl diisocyanate (e.g. Desmodur® W from Bayer AG) and mixtures of the aforementioned polyisocyanates. Additionally preferred polyisocyanate parent structures are the polyisocyanates derived from such a cycloaliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may be ppolyisocyanate prepolymers having urethane structural units which are obtained by reaction of polyols with a stoichiometric excess of aforementioned cycloaliphatic polyisocyanates. Such polyisocyanate prepolymers are described for example in U.S. Pat. No. 4,598,131. Particularly preferred cycloaliphatic polyisocyanates are isophorone diisocyanate and 4,4′-methylenedicyclohexyl diisocyanate and/or the biuret dimers thereof and/or the allophanate dimers thereof and/or the isocyanurate trimers thereof.

The at least one silane used for reaction with at least one organic constituent e2) bearing on average two or more NCO-groups prior to incorporation of e2) into component E) is preferably
at least one compound of the formula (Ia)

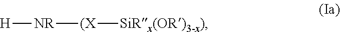

and/or at least one compound of the formula (IIa)

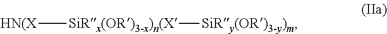

where the substituents have the definitions stated above including the preferred definitions.

Preferred compounds (Ia) are aminoalkyltrialkoxysilanes, such as, preferably, 2-aminoethyltrimethoxysilane, 2-aminoethyltriethoxysilane, 3-aminopropyltrimethoxysilane, 3-aminopropyltriethoxysilane, 4-amino-butyltrimethoxysilane, 4-aminobutyltriethoxysilane. Particularly preferred compounds (Ia) are N-(2-(trimethoxysilyl)ethyl)alkylamines, N-(3-(tri-methoxysilyl)propyl)alkylamines, N-(4-(trimethoxysilyl)butyl)alkylamines, N-(2-(triethoxysilyl)ethyl)alkylamines, N-(3-(triethoxysilyl)propyl)alkylamines and/or N-(4-(triethoxysilyl)butyl)alkylamines. Especially preferred is N-(3-(trimethoxysilyl)propyl)butylamine. Aminosilanes of these kinds are available for example under the brand name DYNASYLAN® from DEGUSSA or Silquest® from OSI.

Preferred compounds (Ila) are bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine and/or bis(4-butyltriethoxysilyl)amine. Especially preferred is bis(3-propyltrimethoxysilyl)amine. Aminosilanes of these kinds are available for example under the brand name DYNASYLAN® from DEGUSSA or Silquest® from OSI.

### Optional Constituent e3)

Optionally present constituent e3) is an organic constituent bearing on average two or more NCO-groups, which is different from e2). In particular, optionally present constituent e3) does not contain any silane modified NCO-groups.

Optionally present constituent e3) may be identical to or different from constituent b2). Preferably, constituent e3) bears on average more than two NCO-groups.

Preferably, the at least one organic constituent e3) optionally present in component E) has an aliphatic or cycloaliphatic structure and/or a parent structure that is derived from an aliphatic or cycloaliphatic polyisocyanate by trimerization, dimerization, urethane formation, biuret formation, uretdione formation and/or allophanate formation. Trimers, i.e., isocyanurates, of IPDI (isophorone diisocyanate) and/or HDI (hexamethylene diisocyanate) are particularly preferred.

Suitable aliphatic polyisocyanates are preferably substituted or unsubstituted aliphatic polyisocyanates such as tetramethylene 1,4-diisocyanate, hexamethylene 1,6-diisocyanate, 2,2,4-trimethylhexane 1,6-diisocyanate, ethylene diisocyanate, dodecane 1,12-diisocyanate, and mixtures of the aforementioned polyisocyanates. Suitable polyisocyanate parent structures may be polyisocyanate prepolymers having urethane structural units which are obtained by reaction of polyols with a stoichiometric excess of aforementioned aliphatic polyisocyanates. Particularly preferred polyisocyanate parent structures are hexamethylene diisocyanate and/or its biuret dimer and/or allophanate dimer and/or isocyanurate trimer and/or its uretdione, and also mixtures of the stated polyisocyanate parent structures. Especially preferred polyisocyanate parent structures are hexamethylene diisocyanate and/or its isocyanurate trimer, optionally together with its uretdione.

Suitable cycloaliphatic polyisocyanates are preferably substituted or unsubstituted cycloaliphatic polyisocyanates such as isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate and 4,4′-methylendicyclohexyl diisocyanate and mixtures of the aforementioned polyisocyanates. Suitable polyisocyanate parent structures may be polyisocyanates derived from a cycloaliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may be polyisocyanate prepolymers having urethane structural units which are obtained by reaction of polyols with a stoichiometric excess of aforementioned cycloaliphatic polyisocyanates. Particularly preferred cycloaliphatic polyisocyanates are isophorone diisocyanate and 4,4′-methylenedicyclohexyl diisocyanate and/or the biuret dimers thereof and/or the allophanate dimers thereof and/or the isocyanurate trimers thereof.

### Optional Component F)

Optional component F) is a reducer component and comprises at least one organic solvent f1). Component F) is used for diluting the to-be-prepared coating composition and for this reason comprises at least one organic solvent f1) and preferably consists of the at least one organic solvent f1). Examples of such organic solvents include the ones already mentioned hereinbefore in connection with constituents a1) and b1) and c1) and d1) and e1). Component F) may comprise more than one organic solvent f1). The at least one organic solvent f1) may the identical to or different from the at least one organic solvent a1) and/or b1) and/or c1) and/or d1) and/or e1). If more than one organic solvent is used as a1) and/or b1) and/or c1) and/or d1) and/or e1) and/or f1) it may be that a1) and/or b1) and/or c1) and/or d1) and/or e1) and/or f1) are both partially identical and partially different.

### Multilayer Coating System

A further subject-matter of the present invention is a multilayer coating system being present on an optionally pre-coated substrate, preferably obtainable by said method of preparing a multilayer coating system, and comprising at least three coatings layers L1, L2 and L3 being different from one another and preferably being positioned adjacently to each other, namely
a first coating layer L1 applied over at least a portion of an optionally pre-coated substrate, said layer L1 being obtainable from an inventive primer coating composition,
a second coating layer L2 applied over the first coating layer L1, and
a third coating layer L3 applied over the second coating layer L2, wherein the third coating layer L3 preferably is the outermost coating layer of the multilayer coating system.

All preferred embodiments described above herein in connection with the primer coating system, the primer coating composition, the aforementioned use and method, and the coated substrate as well as the method for preparing a multilayer coating system and in each case the preferred embodiments thereof, are also preferred embodiments of the multilayer coating system as such.

Preferably, the multilayer coating system is obtained by the aforementioned method of preparing a multilayer coating system.

### Methods

### 1. Humidity Exposure

Humidity exposure is determined according to the high humidity test (96 h) of GMW 14729 (4^{th} edition, August 2020).

### 2. Water Vapor Permeability

Water vapor permeability is determined according to test method A (dry cup method) according to ASTM D1653 (2021). The test was performed at 38° C. and 90% RH (relative air humidity). Weight change was determined by the difference between initial weight and the weight at different times during and after performance of the test.

### 3. Moisture Uptake

Moisture uptake (water uptake) was determined via a weight change study. Weight change of coated panels was determined by the difference between initial coated panel weight and the weight after humidity exposure and subsequent storage of the coated panel for 5 days and optionally again 6 months after said exposure at ambient conditions.

### 4. Dynamic Light Scattering (DLS)

The average particle size of constituent a3) (and the silica starting material used) is determined by Dynamic light scattering (DLS) method following ISO 21501-4 standard. Measurement was done using a Beckman coulter instrument (Model: Delsa Nano C particle analyzer; Software: Delsa Nano 2.31). The sample solution was prepared approximately 0.01% in filtered distilled water prior to check.

### 5. Non-Volatile Fraction

The non-volatile fraction (solid fraction, solid content) is determined according to DIN EN ISO 3251:2018-07 at 140° C. for 60 min.

### 6. Glass Transition Temperature

The glass transition temperature is measured by means of DSC measurements in accordance with DIN EN ISO 11357-2 (2019-03)

### EXAMPLES

The following examples further illustrate the invention but are not to be construed as limiting its scope. ‘Pbw’ means parts by weight. If not defined otherwise, ‘parts’ means ‘parts by weight’.

### 1. Preparation of 2K Primer Coating Systems and Coating Material Compositions Obtainable Therefrom

1.1 The “A”-components of a 2K primer coating system IPC1 (inventive) and of a 2K primer coating system CPC1 (comparative) and CPC2 (comparative) have been prepared by mixing the constituents listed in Table 1.1 in this order.

TABLE 1.1
“A”-components of IPC1 and CPC1 as well as CPC2

| | IPC1 | | |
|---|---|---|---|
| | (inventive); | CPC1 | CPC2 |
| | amount | (comparative); | (comparative); |
| Constituent | [pbw] | amount [pbw] | amount [pbw] |
| Pigment paste P1 | 5.39 | 5.39 | 5.39 |
| Cyclohexanone | 0.83 | 0.83 | 0.83 |
| Xylene (Mixed isomers) | 2.58 | 2.58 | 2.58 |
| Isopropanol | 0.21 | 0.21 | 0.21 |
| NMP | 1.54 | 1.54 | 1.54 |
| AS1 | 0.22 | 0.22 | 0.22 |
| Epoxy resin | 2.28 | 2.28 | 2.28 |
| CPO | 10.78 | 10.78 | 10.78 |
| Pigment paste P2 | 0.01 | 0.01 | 0.01 |
| Pigment paste P3 | 0.01 | 0.01 | 0.01 |
| Pigment paste P4 | 0.02 | 0.02 | 0.02 |
| Pigment paste P5 | 0.02 | 0.02 | 0.02 |
| Xylene (Mixed isomers) | 0.84 | 0.84 | 0.84 |
| ACL | 24.74 | 24.74 | 24.74 |
| AS2 | 27.70 | 27.70 | 27.70 |
| Methyl propyl ketone | 11.87 | 11.87 | 11.87 |
| Nacure ® 4167 | 0.15 | 0.15 | 0.15 |
| TIB KAT ® 216 | 0.01 | 0.01 | 0.01 |
| 2-Ethylhexylacid | 0.07 | 0.07 | 0.07 |
| phosphate | | | |
| Silica-silane condensate | 8.93 | — | — |
| BYK 3565 | 1.79 | — | 1.79 |
| Σ | 100.00 | 89.28 | 91.07 |

Pigment paste P1 contains 60 wt.-% of a titanium dioxide pigment and further comprises an alkyl resin. Pigment paste P2 contains 6 wt.-% of a carbon black pigment and further comprises an alkyl resin. Pigment paste P3 contains 10 wt.-% of an organic blue pigment and further comprises an alkyl resin. Pigment paste P4 contains 47 wt.-% of an inorganic yellow pigment and further comprises an alkyl resin. Nacure® 4167 is a commercially available amine neutralized phosphate catalyst. TIB KAT® 216 is a liquid tin catalyst based on dioctyl tin compounds. BYK 3565 is a commercially available surface-active additive. AS1 and AS2 are both commercially available aromatic solvent mixtures, which are different from one another. NMP is N-Methylpyrrolidone. CPO is a commercially available solution of a chlorinated polyolefin (solid content 19.8 wt.-%). ACL is Acrydic® CL-408, a commercially available solventborne chlorinated polypropylene modified with an acrylic resin, which is OH-functional (solid content 44.0 to 46 wt.-%). The epoxy resin is a reaction product of bisphenol A and DGEBA, a bisphenol A diglycidyl ether, and has an epoxy equivalent weight of 465 to 500.

The silica-silane condensate used is a MTMS-silica condensate and was prepared prior to its incorporation into the “A”-component of IPC1 by reacting methyl trimethoxysilane (MTMS) with a commercially available nano-silica dispersion (LUDOX® AS-40). For preparing the silica-silane condensate, MTMS (0.45 moles) was mixed with acetic acid (1.45 wt.-%) and the mixture was cooled to 0° C. Then, water (9.7 wt.-%; 0.54 moles) was added as well as LUDOX® AS-40 (24.5 wt.-%; 0.97 moles, wherein 0.16 moles thereof correspond to silica and the remaining parts corresponds to water also present within this product). Thus, the molar ratio of MTMS to silica to was 0.45:0.16, i.e., about 2.8:1. The resulting mixture was then stirred at room temperature for 12 to 16 h. Then, acetic acid and TBAA (tetrabutylammonium acetate) as catalyst were added (3.13 wt.-% acetic acid and 0.17 wt.-% TBAA) and the mixture was stirred for 2 to 3 h maintaining a pH of 5.1. The resulting mixture (solid content 43 wt.-%) was then diluted with isopropyl alcohol (1:1 by weight) and then used in this form as silica-silane condensate for preparing the “A”-component of IPC1.

1.2 The “B”-component for use in the 2K primer coating systems IPC1, CPC1 and CPC2 has been prepared by mixing the constituents listed in Table 1.2 in this order.

TABLE 1.2
“B”-components of IPC1 and CPC1 as well as CPC2

| Constituent | Amount [wt.-%] |
|---|---|
| Butyl acetate | 20.02 |
| Dynasylan ® 1189 | 1.5 |
| Dynasylan ® 1124 | 26.9 |
| Desmodur ® N3600 | 51.58 |
| Σ | 100.00 |

Desmodur® N3600 is a commercially available aliphatic polyisocyanate (HDI trimer). Dynasylan® 1189 is N-(3-(Trimethoxysilyl)propyl)butylamine. Dynasylan® 1124 is Bis(trimethoxysilylpropyl)amine.

1.3 Primer coating material compositions were prepared from mixing an “A”-component with the “B”-component of the primer coating systems IPC1 and CPC1 as well as CPC2, respectively.

For preparation of a composition obtainable from IPC1 the “A”- and “B”-components were mixed in a weight ratio of 14.4:1 with each other (“A” to “B”). For preparation of a composition obtainable from CPC1 and CPC2 the “A”- and “B”-components were mixed in a weight ratio of 12.9:1 with each other (“A” to “B”).

The mixing ratios were calculated and chosen such that an excess of about 10-12 wt.-% of polyisocyanates originating from component “B” is still present in the resulting compositions in order to also cure a subsequently to be applied basecoat film via NCO-migration when applied on top of a primer coating film being obtainable from applying the primer coating material composition onto a surface of a substrate.

### 2. Preparation of a 2K Clearcoat System and a Clearcoat Material Composition Obtainable Therefrom

2.1 The “A”-component of a 2K clearcoat system ICC1 has been prepared by mixing the constituents listed in Table 2.1 in this order.

TABLE 2.1
“A”-component of ICC1

| Constituent | ICC1, amount [pbw] |
|---|---|
| Acrylic resin 1 | 6.78 |
| Acrylic resin 2 | 14.00 |
| Acrylic resin 3 | 34.11 |
| AS3 | 17.27 |
| Butyl acetate | 15.40 |
| Additive 1 | 2.28 |
| Additive 2 | 0.99 |
| Additive 3 | 0.05 |
| Additive 4 | 0.03 |
| Nacure ® 4167 | 2.18 |
| Catalyst 1 | 0.74 |
| 2-Ethylhexylacid phosphate | 1.19 |
| Butyl acetate | 2.98 |
| Butyl acetate | 1.99 |
| Σ | 100.00 |

Catalyst 1 is a commercially available catalyst, namely TIB KAT® 216 (DOTL), which is a liquid tin catalyst based on dioctyl tin compounds. Additive 1 is a commercially available liquid hydroxyphenyl-triazine (HPT) UV absorber. Additive 2 is a commercially available liquid hindered amine light stabilizer. Additive 3 is a commercially available silicone containing surface additive. Additive 4 is a commercially available defoamer. Nacure® 4167 has already been described hereinbefore. AS3 is a commercially available aromatic solvent mixture, which is different from AS1 and AS2 identified hereinbefore. Acrylic resin 1 is a solution of an OH-functional (meth)acrylic resin having a T_{g} of −15° C. prepared from N-butyl methacrylate, styrene 4-hydroxybutyl acrylate and 2-hydroxyethyl acrylate (solid content: 65 wt). Acrylic resin 2 is a dispersion of an OH-functional (meth)acrylic resin having a T_{g} of +34° C. prepared from 3-hydroxypropyl methacrylate, 2-etyhylhexyl (meth)acrylate and cyclohexyl (meth)acrylate (solid content: 67.5 wt.-%). Acrylic resin 3 is a dispersion of an OH-functional (meth)acrylic resin having a T_{g} of +46° C. prepared from n-Butyl methacrylate, styrene, cyclohexyl methacrylate, 2-hydroxypropyl methacrylate and 2-hydroxyethyl methacrylate (solid content: 60.0 wt.-%).

2.2 The “B”-component of the 2K clearcoat system ICC1 is a polyisocyanate. Part of the NCO-groups of said polyisocyanate (the product Desmodur® N3600 has been used as starting material) has been silanized by making use of two different organosilanes, namely Dynasylan® 1189 and Dynasylan® 1124) prior to its use in/as component “B”. Desmodur® N3600 is a commercially available aliphatic polyisocyanate (HDI trimer). Dynasylan® 1189 is N-(3-(Trimethoxysilyl)propyl)butylamine. Dynasylan® 1124 is Bis(trimethoxysilylpropyl)amine. The “B” component of ICC1 is commercially available (“B”-component of iGloss® refinish).

2.3 Clearcoat material compositions were prepared from mixing the “A”-component with the “B”-component of the clearcoat system ICC1 in a weight ratio of 1:1 with each other (“A” to “B”).

3. Properties of Primer Coating Films and Layers Obtained from Primer Coating Material Compositions

### 3.1 Water Vapor Permeability

Free-standing primer coating films were obtained by spraying either the primer composition IPC1 or CPC1 separately on Tedlar®films using a p-Mac spray applicator. After 10 minutes of room temperature flash-off both the films were baked in an oven at 50° C. for 30 minutes to obtain dry film with 0.5 mil (12.7 μm) thickness. Then, the free-standing primer coating films were carefully removed from the Tedlar® film using a sharp knife.

Water vapor permeability of free-standing primer films was measured according to the method disclosed hereinbefore. The results are illustrated in FIG. 1. The graph represents water vapor permeability of free-standing control primer film (a primer film obtained from a composition that has in turn been obtained from comparative primer coating system CPC1) versus the inventive primer film (a primer film obtained from a composition that has in turn been obtained from inventive primer coating system IPC1) containing about 9 wt.-% silica-silane condensate, based on the total weight of primer composition IPC1 before application. As it is shown in FIG. 1 a significant difference in water vapor permeability is observed: the film obtained from IPC1 is about 35% less permeable than the control film obtained from CPC1. Hence, without the silica-silane condensate a poorer moisture barrier property is observed.

In Table 3.1a and 3.1b the respective data illustrated in FIG. 1 are summarized.

TABLE 3.1a
Water vapor permeability data - IPC1 film

| | Weight of the | Weight | |
|---|---|---|---|
| | films at certain | increase | |
| | times during test | (water) | Weight increase |
| | [g] | [g] | [% change] |
| Day 1 | 163.35 | — | — |
| Day 2 | 163.35 | 0.00 | 0.0 |
| Day 3 | 163.42 | 0.07 | 0.0 |
| Day 4 | 163.50 | 0.15 | 0.1 |
| Day 14 | 163.86 | 0.51 | 0.3 |

TABLE 3.1b
Water vapor permeability data - CPC1 film

| | Weight of the | Weight | |
|---|---|---|---|
| | films at certain | increase | |
| | times during test | (water) | Weight increase |
| | [g] | [g] | [% change] |
| Day 1 | 165.92 | — | — |
| Day 2 | 165.92 | 0.00 | 0.0 |
| Day 3 | 166.01 | 0.09 | 0.1 |
| Day 4 | 166.05 | 0.13 | 0.1 |
| Day 14 | 166.70 | 0.78 | 0.5 |

3.2 Moisture Uptake after Humidity Exposure and Storage

A carbon fiber (C-fiber) reinforced plastic substrate was used as a substrate, namely is the product Ultramid®XA3418, which is a carbon fiber reinforced polyamide. A primer coating material composition obtained from primer coating system IPC1 or CPC1 or CPC2 prepared as described in item 1.3 was applied to a surface of the substrate to form a primer film and flashed for 10 minutes at ambient conditions (room temperature). A commercially available pigmented solventborne basecoat material composition (Hot Pepper Red) was then sprayed onto the primer film to form a basecoat film and flashed for 10 minutes at ambient conditions (room temperature). Then, a clearcoat material composition obtained from clearcoat system ICC1 prepared as described in item 2.3 was applied onto the basecoat film and flashed for 10 minutes at ambient conditions (room temperature) and then all films were simultaneously baked for 30 minutes at 122° F. (50° C.) substrate temperature.

The dry film thickness of each primer layer obtained after curing from each primer film was in a range of from 0.5 to 1 mil (12.7 μm to 25.4 μm). The dry film thickness of each basecoat layer obtained after curing from each basecoat film was in a range of from 0.6 to 1 mil (15.24 μm to 25.4 μm) and the dry film thickness of each clearcoat layer obtained after curing from each clearcoat film was in a range of from 1.9 to 2.1 mil (48.26 μm to 53.34 μm).

Moisture uptake was measured according to the method disclosed hereinbefore. The effect of humidity on coated PA-CF (carbon fiber reinforced polyamide) substrates has been studied by exposing the coated samples (PA-CF substrate), which were coated with all three layers (i.e., primer/basecoat/clearcoat) into the humidity chamber according to the test method mentioned in the ‘methods’ section. Water uptake was determined 5 days and 6 months after having performed the humidity test (during that time the coated substrates were stored at room temperature at ambient conditions). All coated substrates had similar coating layers except of the primer, which was prepared either by using the primer coating system IPC1 or CPC1 or CPC2. Water uptake has been studied by measuring the weight gain after exposure and storage: weight change of the coated panels was determined by the difference between initial coated panel weight and the weight after the humidity exposure (after 5 days equilibrium and after 6 months).

Significantly less moisture (water) uptake (~38 to 40 wt. %) observed for substrates coated with a multicoat comprising an inventive primer film (a primer film obtained from a composition that has in turn been obtained from inventive primer coating system IPC1) compared to substrates coated with a multicoat comprising a control primer (a primer film obtained from a composition that has in turn been obtained from comparative primer coating system CPC1 or CPC2) as shown in Table 3.2. In Table 3.2 also an uncoated panel is investigated as further control substrate.

TABLE 3.2
Effect of moisture uptake with uncoated and coated panels

| | | Weight | Weight | Weight | Weight |
|---|---|---|---|---|---|
| | Initial | measured | difference | measured | difference |
| | weight | 5 days | [% | 6 months | [% |
| | before | after | change; | after | change; |
| | humidity | humidity | 5 days | humidity | 6 months |
| | exposure | exposure | vs. | exposure | vs. |
| | [g] | [g] | initial] | [g] | initial] |
| Uncoated | 29.254 | 30.0201 | +2.61 | nd | nd |
| panel | | | | | |
| Panel | 31.235 | 31.706 | +1.51 | 31.671 | +1.40 |
| coated with | | | | | |
| composition | | | | | |
| obtained | | | | | |
| from CPC1 | | | | | |
| Panel | 30.149 | 30.596 | +1.48 | nd | nd |
| coated with | | | | | |
| composition | | | | | |
| obtained | | | | | |
| from CPC2 | | | | | |
| Panel | 31.019 | 31.302 | +0.91 | 31.295 | +0.89 |
| coated with | | | | | |
| composition | | | | | |
| obtained | | | | | |
| from IPC1 | | | | | |

nd = not determined

1. A primer coating system comprising at least two components A) and B) and optionally at least one further component C) being different from one another and being separate from each other,
wherein component A) comprises at least constituents a2) and a3) and optionally at least one constituent a1), which are different from one another, namely
optionally at least one organic solvent a1),
at least one polymer a2), which contains functional groups, that are reactive towards NCO-groups, and
at least one condensation product a3), which is obtained at least by reaction of (i) at least one organosilane bearing at least one hydrolyzable group with (ii) at least one kind of silica, wherein a molar ratio of the at least one organosilane and the at least one kind of silica used to each other is in a range of from 10:1 to 1:1,
wherein component B) comprises at least constituent b2) and optionally at least one constituent b1), which are different from one another, namely
optionally at least one organic solvent b1), and
at least one organic constituent b2) bearing on average two or more NCO-groups, and
wherein optional component C) is a reducer component and comprises at least one organic solvent c1).

2. The primer coating system according to claim 1, wherein the at least one condensation product a3) is present in component A) in an amount in a range of from 1.0 to 25.0 wt.-%, based on the total weight of component A).

3. The primer coating system according to claim 1, wherein condensation product a3) has an average particle size in a range of from 10 to 100 nm, measured by DLS (dynamic light scattering).

4. The primer coating system according to claim 1, wherein the molar ratio of the at least one organosilane and the at least one kind of silica used for preparing condensation product a3) to each other is in a range of from 8:1 to 1:1.

5. The primer coating system according to claim 1, wherein the condensation reaction of the at least one organosilane bearing at least one hydrolyzable group with the at least one kind of silica takes place in aqueous medium.

6. The primer coating system according to claim 1, wherein component A) further comprises
at least one catalyst a4) suitable for crosslinking of Si-containing functional groups, the at least one catalyst a4) being different from any of constituents a1) to a3)
and/or
at least one catalyst a5) suitable for crosslinking of NCO-groups, the at least one catalyst a5) being different from any of constituents a1) to a3) and from catalyst a4).

7. The primer coating system according to claim 1, wherein
the at least one organic constituent b2) present in component B) has an aliphatic or cycloaliphatic structure and/or a parent structure that is derived from an aliphatic or cycloaliphatic polyisocyanate by trimerization, dimerization, urethane formation, biuret formation, uretdione formation and/or allophanate formation,
and/or
wherein component B) further comprises at least one organosilane constituent b3) being different from each of constituents b1) and b2) and bearing at least one hydrolyzable group.

8. The primer coating system according to claim 1, wherein component A) comprises at least one of the following constituents a6) to a8), which are different from one another, different from each of constituents a1) to a3), different from at least one catalyst a4) suitable for crosslinking of Si-containing functional groups, the at least one catalyst a4) being different from any of constituents a1) to a3), and different from at least one catalyst a5) suitable for crosslinking of NCO-groups, the at least one catalyst a5) being different from any of constituents a1) to a3) and from catalyst a4), namely
at least one epoxy resin as constituent a6),
at least one chlorinated polyolefin as constituent a7),
at least one pigment and/or filler as constituent a8).

9. The primer coating system according to claim 1, wherein component A) comprises at least one levelling agent and/or dispersing agent as additive constituent a9).

10. A primer coating composition,
which is obtained by mixing at least components A) and B) and optionally C) of the primer coating system according to claim 1 with each other
or
which at least comprises constituents (i), (ii) and (iii) and optionally also (iv), which are different from one another, namely
(i) optionally at least one organic solvent,
(ii) at least one film-forming polymer, which is self-crosslinking or externally crosslinking, which contains functional groups that are reactive towards NCO-groups,
(iii) at least one condensation product, which corresponds to the condensation product a3), and
(iv) optionally at least one crosslinking agent at least in case the at least one film-forming polymer (ii) is an externally crosslinking polymer.

11. The primer coating composition according to claim 10, wherein it contains an excess of constituent b2) bearing on average two or more NCO-groups such that upon migration of said constituent into an intermediate coating film, applied on top of a primer coating film obtained from the primer coating composition onto a substrate, at least partial curing of the intermediate coating film is achieved, when said intermediate coating film contains at least one constituent, which contains functional groups that are reactive towards NCO-groups.

12. A method of using the primer coating composition according to claim 10, the method comprising using the primer coating composition for improving water and/or moisture resistance of a cured primer coating film obtained therefrom and/or of a cured multilayer coating system containing at least one cured primer coating film, said cured primer coating film being obtained from the primer coating composition.

13. A method of coating a substrate comprising at least a step 1), namely
1) applying a primer coating composition according to claim 10 at least partially to at least one surface of an optionally pre-coated substrate and forming a primer coating film on said surface,
1a) and optionally at least one further step 1a) of curing the at least one primer coating film obtained after step 1) to obtain at least one cured primer coating layer onto said surface.

14. A coated substrate, which is obtained by the method according to claim 13.

15. A method of preparing a multilayer coating system on at least one surface of an optionally pre-coated substrate comprising at least steps 1) to 3) and optionally 4), namely
1) applying a first coating composition at least partially to at least one surface of an optionally pre-coated substrate and forming a first coating film on said surface,
wherein the first coating composition is a primer coating composition according to claim 10, and
2) applying at least one basecoat composition as at least one second coating composition to the first coating film present on the substrate obtained after step 1), and forming a second coating film,
3) applying a topcoat composition, as third coating composition to the second coating film present on the substrate obtained after step 2), and forming a third coating film, and
4) optionally jointly curing the first, second and third coating films to obtain a multilayer coating system comprising cured first, second, and third coating layers.

16. A multilayer coating system being present on an optionally pre-coated substrate, and comprising at least three coatings layers L1, L2 and L3 being different from one another, namely
a first coating layer L1 applied over at least a portion of an optionally pre-coated substrate, said layer L1 being obtained from a primer coating composition according to claim 10,
a second coating layer L2 applied over the first coating layer L1, and
a third coating layer L3 applied over the second coating layer L2.

17. The primer coating system according to claim 1, wherein the condensation reaction of the at least one organosilane bearing at least one hydrolyzable group with the at least one kind of silica is catalyzed by at least one organic acid.

18. The primer coating system according to claim 6, wherein the catalyst a4) is selected from the group consisting of phosphorus-containing organic constituents, acyclic phosphoric diesters, acyclic phosphoric monoesters, cyclic phosphoric diesters and cyclic phosphoric monoester, wherein each of the aforementioned phosphoric diesters and monoesters is optionally present in a form of an adduct with at least one amine.

19. The primer coating system according to claim 6, wherein the catalyst a5) is selected from the group consisting of organotin catalysts.

20. The primer coating system according to claim 7, wherein component B) further comprises at least one organosilane constituent b3) being different from each of constituents b1) and b2), bearing at least one hydrolyzable group and additionally at least one non-hydrolyzable organic residue.
